(19) United States
(12) Patent Application Publication
(10) Pub. No.: US 2014/0089297 A1
(43) Pub. Date: Mar. 27, 2014

(54) SYSTEM AND METHOD FOR ANALYSING DATA FROM MULTIPLE PERSPECTIVES

(71) Applicant: New BIS Safe Luxco S.á r.l., Luxembourg (LU)

(72) Inventors: Andrew John CARDNO, San Diego, CA (US); Mukesh GORDHAN, San Diego, CA (US)

(21) Appl. No.: 14/035,247

(22) Filed: Sep. 24, 2013

Related U.S. Application Data
(63) Continuation-in-part of application No. PCT/NZ2012/000045, filed on Mar. 23, 2012.
Application No. PCT/NZ2012/000045 is a continuation-in-part of application No. 13/000,323, filed on Jul. 12, 2011.
(60) Provisional application No. 61/467,260, filed on Mar. 24, 2011.
(60) Provisional application No. 61/074,347, filed on Jun. 20, 2008.
(60) Provisional application No. 61/093,428, filed on Sep. 1, 2008.
(60) Provisional application No. 61/101,670, filed on Sep. 30, 2008.
(60) Provisional application No. 61/101,672, filed on Sep. 30, 2008.
(60) Provisional application No. 61/107,665, filed on Oct. 22, 2008.
(60) Provisional application No. 61/115,036, filed on Nov. 15, 2008.
(60) Provisional application No. 61/118,211, filed on Nov. 26, 2008.
(60) Provisional application No. 61/140,556, filed on Dec. 23, 2008.
(60) Provisional application No. 61/145,775, filed on Jan. 20, 2009.
(60) Provisional application No. 61/146,133, filed on Jan. 21, 2009.
(60) Provisional application No. 61/146,525, filed on Jan. 22, 2009.
(60) Provisional application No. 61/146,430, filed on Jan. 22, 2009.
(60) Provisional application No. 61/161,472, filed on Mar. 19, 2009.

(51) Int. Cl. G06F 17/30

(52) U.S. Cl. CPC G06F 17/30277
USPC 707/722

(57) ABSTRACT

In a data visualisation system, a method of generating multiple perspective views of a graphical representation of data based on a single database query, the method including the steps of: receiving a database query, determining the query data associated with the database query retrieving the query data from a data storage module that is in communication with the data visualisation system, generating multiple perspective query results from the database query, and generating a graphical representation based on one or more of the multiple perspective query results.

This application is a Continuation-in-Part application of PCT/NZ2012/000045, filed 23 Mar. 2012, which claims benefit of U.S. Provisional Ser. No. 61/467,260, filed 24 Mar. 2011. This application is a Continuation-in-Part of U.S. Ser. No. 13/000,323, filed 20 Dec. 2010, which is a National Stage of PCT/NZ2009/000114, filed 19 Jun. 2009, which claims benefit of U.S. Provisional Ser. Nos. 61/074,347, filed 20 Jun. 2008, 61/093,428, filed 1 Sep. 2008, 61/101,670, filed 30 Sep. 2008, 61/101,672, filed 30 Sep. 2008, 61/107,665, filed 22 Oct. 2008, 61/115,036, filed 15 Nov. 2008, 61/118,211, filed 26 Nov. 2008, 61/140,556, filed 23 Dec. 2008, 61/145,775, filed 20 Jan. 2009, 61/146,133 filed 21 Jan. 2009, 61/146,430, filed 22 Jan. 2009, 61/146,525, filed 22 Jan. 2009, and 61/161,472, filed 19 Mar. 2009. All applications are incorporated herein by reference. To the extent appropriate, a claim of priority is made to each of the above disclosed applications.

### FIELD OF THE INVENTION

The present invention relates to an improved system and method for analysing data from multiple perspectives. In particular, the present invention relates to a method of or system for generating multiple perspective views of a graphical representation of data based on a single database query.

### BACKGROUND

When analysing data, different results can be provided depending on the perspective in which the data is viewed or analysed.

For example, the data analysis may be performed from a financial perspective where the data analysed may be transaction specific. According to another example, the data analysis may be performed from a machine or device perspective where the data analysis may be machine or device specific. As a further example, the data analysis may be performed from a marketing, consumer or customer perspective where the data analysis may be location specific.

That is, for different query purposes, it is beneficial to look at data in different ways that tie up with a specific desired purpose. For example, the data may be analysed and viewed in the context of location, time, customer groups, device groups, configurations or themes, for example.

In known data analysis systems, the end user is required to understand the structure of the data that is being analysed and perform programmatic query functions to return different sets of results for each different query purpose. That is, the end user must create and/or re-write the query functions each time a different analytical perspective is needed.

This clearly provides a burden on the end user in having to train themselves or other individuals in order to ensure that correct queries are generated so that accurate analysis of the data is performed.

Data visualization systems have been developed to enable the data analysis results to be visualized in a user friendly and intuitive manner. One such system has been created by the current applicants and is described in U.S. Ser. No. 13/000,323 entitled “METHODS, APPARATUS AND SYSTEMS FOR DATA VISUALIZATION AND RELATED APPLICATIONS” filed 20 Dec. 2010.

An object of the present invention is to provide an improved data visualization system or method that provides analytical data query results showing multiple perspectives.

A further object of the present invention is to provide an improved data visualization system or method that improves efficiency in generating multiple perspective query results.

Each object is to be read disjunctively with the object of at least providing the public with a useful choice.

The present invention aims to overcome, or at least alleviate, some or all of the afore-mentioned problems.

Further objects and advantages of the invention will be brought out in the following portions of the specification, wherein the detailed description is for the purpose of fully disclosing the preferred embodiment of the invention without placing limitations thereon.

The background discussion (including any potential prior art) is not to be taken as an admission of the common general knowledge.

### SUMMARY OF THE INVENTION

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components that the use directly references, but optionally also the inclusion of other non-specified components or elements.

According to one aspect, the present invention provides in a data visualisation system, a method of generating multiple perspective views of a graphical representation of data based on a single database query, the method comprising the steps of: receiving a database query, determining the query data associated with the database query retrieving the query data from a data storage module that is in communication with the data visualisation system, generating multiple perspective query results from the database query, and generating a graphical representation based on one or more of the multiple perspective query results.

### BRIEF DESCRIPTION OF THE DRAWINGS

Embodiments of the present invention will now be described, by way of example only, with reference to the accompanying drawings, in which:

FIG. 1A shows a NASDAQ Heat Map Example;

FIG. 1B shows a NASDAQ Heat Map Intra Day Data Example;

FIG. 1C shows a diagrammatical representation of some key terms;

FIG. 2A shows a system concept diagram according to an embodiment of the present invention;

FIG. 2B shows an overview of the software modules in the described system;

FIG. 3 shows a general overview of the data flow within the system according to an embodiment of the present invention;

FIG. 4 shows an architectural overview of the described solution according to an embodiment of the present invention;

FIG. 5 shows a high-level system delivery overview of the described solution according to an embodiment of the present invention;

FIG. 6A shows a general data flow diagram according to an embodiment of the present invention;

FIG. 6B shows a flow diagram according to an embodiment of the present invention;

FIG. 7 shows the concept of layers according to an embodiment of the present invention;

FIG. 8 shows a graphical representation of a performance analysis according to an embodiment of the present invention;

FIG. 9 shows a graphical representation of a machine analysis according to an embodiment of the present invention;

FIG. 10 shows a graphical representation of a customer or marketing analysis according to an embodiment of the present invention;

FIG. 11 shows a representation of various slowly changing dimensions according to an embodiment of the present invention; and

FIG. 12 shows a system block diagram according to an embodiment of the present invention.

### DETAILED DESCRIPTION OF THE INVENTION

### First Embodiment

The following described invention is suitable for use in conjunction with other methods, and the incorporation into one or more systems, for example as described in METHODS, APPARATUS AND SYSTEMS FOR DATA VISUALISATION AND RELATED APPLICATIONS (earlier filed by the applicant in the entirety as U.S. provisional patent application Ser. No. 61/074,347 filed on 20 Jun. 2008), which is incorporated by reference, and a portion of which herein follows.

Four key terms (or concepts) form the foundation of the specification set out in this document and accordingly have been defined as follows:

The four key terms are:

### Business Performance Drivers (BPD)

### BPD Packages

### Visual Designs

### Visual Documents

The key terms are defined as follows:

Business Performance Drivers (BPDs): A Business Performance Driver (BPD) is a business metric used to quantify a business objective. For example, turnover, sales. BPDs are Facts (sometimes referred to as measures). Facts are data items that can be counted. For example, Gross Sales; Units Sold.

BPDs comprise of:
1. Measures: Data items that can be counted. For example, Gross Sales; Units Sold.
2. Dimensions: Data items that can be categorized. For example, Gender; Locations.
3. Restrictions can be applied to BPDs. These filter the data included. For example a restriction of ‘State=“CA”’ may be specified to only include data for California.
4. Normalizations can be applied to BPDs. These specify (or alter) the time period the BPD refers to. For example—Daily Units Sold, Monthly Profit.
   The combination of BPDs, Restrictions and Normalizations provides the flexibility to create many ways of looking at data without requiring extensive definition effort.

In other words a Business Performance Driver (BPD) is a ‘measure’ that can be normalized. Measures are data items that can be counted. For example, Gross Sales; Units Sold. BPDs might be displayed on visualizations. For example, Revenue earned per store on a map. Restrictions and/or Normalizations could be applied to a BPD. The following table provides examples of these:

| Scenario | Business Example |
|---|---|
| BPD (no | Revenue |
| normalization or | |
| restriction) | |
| BPD with | Revenue earned in the state of |
| restriction | California |
| BPD with | Revenue earned in week 1 of 2008 |
| normalization | |
| BPD with | Revenue earned in the state of |
| restriction and | California in week 1 of 2008 |
| normalization | |

BPD Packages: A BPD Package is made up from a set of related BPDs. This relationship (between a BPD Package and its BPDs) is defined using metadata.

BPD Packages can be thought of as the Visual Document's vocabulary.

Visual Designs: Visual Designs are a classification of the different types of visualizations that a user may choose. Within each Visual Design, there are a number of visualizations. For example, the ‘spatial’ category can have retail store location maps or geographical location maps.

The software solution allows users to select one visualization (one visual form within a Visual Design category) to create a Visual Document.

Visual Document: A Visual Document contains visual representations of data. Access to the data used to construct the visual representation is in many ways analogous to a textual document.

A Visual Document is constructed by applying BPD data to a specific Visual Design. It is designed to illustrate at least one specific point (using the visualization), supports the points made with empirical evidence, and may be extended to provide recommendations based on the points made. The Visual Document is a deliverable to the user.

| Dimensions | Dimensions are data items that can be categorized. For | | | |
|---|---|---|---|---|
| | example, Gender; Locations. | | | |
| | Dimensions might be displayed on visualizations. For | | | |
| | example product categories on a shop floor. | | | |
| Fact | See Business Performance Drivers (BPDs) | | | |
| Measure | See Business Performance Drivers (BPDs) | | | |
| Normalizations | Can be applied to BPDs. These specify (or alter) the | | | |
| | time period the BPD refers to. For example - Daily | | | |
| | Units Sold, Monthly Profit. | | | |
| | The combination of BPDs, Restrictions and | | | |
| | Normalizations provides the flexibility to create many | | | |
| | ways of looking at data without requiring extensive | | | |
| | definition effort. Refer to definition of BPDs for | | | |
| | examples. | | | |
| Restrictions | Can be applied to BPDs or Dimensions. These filter the | | | |
| | data included. For example a restriction of ‘State = | | | |
| | “CA”’ may be specified to only include data for | | | |
| | California. | | | |
| | A BPD or Dimension could be restricted by Compound | | | |
| | Statements (series of restrictions using AND/OR | | | |
| | statements). For example, Revenue from all stores | | | |
| | where state = California AND units sold > 200 units. | | | |
| | Restrictions have the following types: | | | |
| | Restriction | | | Business |
| | Type | Definition | Example | Context |
| | = | Equal to | State = | Revenue |
| | | | ‘CA’ | earned |
| | | | | within the |
| | | | | state of |
| | | | | California |
| | >= | Greater | Units Sold >= | Revenue |
| | | than or | 200 | earned from |
| | | equal to | | stores where |
| | | | | units sold |
| | | | | were greater |
| | | | | than (or |
| | | | | equal to) 200 |
| | | | | units |
| | =< | Less than | Revenue =< | Revenue |
| | | or equal | $50,000 | earned from |
| | | to | | stores where |
| | | | | Revenue was |
| | | | | less than (or |
| | | | | equal to) |
| | | | | $50,000 |
| | > | Greater | Units Sold > | Revenue |
| | | than | 200 | earned from |
| | | | | stores where |
| | | | | the number |
| | | | | of units sold |
| | | | | were greater |
| | | | | than |
| | | | | 200 units |
| | < | Less than | Units Sold < | Revenue |
| | | | 200 | earned from |
| | | | | stores where |
| | | | | the number |
| | | | | of units sold |
| | | | | were less |
| | | | | than |
| | | | | 200 units |
| | IN | In (list) | State IN | Revenue |
| | | | (‘CA’, | earned from |
| | | | ‘NY’) | stores within |
| | | | | the states of |
| | | | | California |
| | | | | and New |
| | | | | York |
| | BETWEEN | Values | Product | Revenue |
| | | between X | Code | earned from |
| | | and Y | between | product |
| | | | ‘124’ and | codes 124 to |
| | | | ‘256’ | 256 |
| | | | | (inclusive) |
| | NOT = | Not Equal | State | Revenue |
| | | to | NOT = CA | earned from |
| | | | | stores |
| | | | | outside the |
| | | | | state of |
| | | | | California. |
| | NOT IN | Not in | State NOT | Revenue |
| | | (list) | IN (‘CA’, | earned from |
| | | | ‘NY’) | outside the |
| | | | | states of |
| | | | | California |
| | | | | and New |
| | | | | York. |
| | NOT | Values not | Store | Revenue |
| | BETWEEN | between X | Code | earned from |
| | | and Y | NOT | stores |
| | | | Between | excluding |
| | | | 105 and | stores with a |
| | | | 110 | store code |
| | | | | between 105 |
| | | | | and 110 |
| | | | | (inclusive). |

Heatmaps: A heat map is a graphical representation of data where the values taken by a variable in a two-dimensional map are represented as colors. A very similar presentation form is a Tree map.

Heat maps are typically used in Molecular Biology to represent the level of expression of many genes across a number of comparable samples (e.g. cells in different states, samples from different patients) as they are obtained from DNA microarrays.

Heat maps are also used in places where the data is volatile and representation of this data as a heat map improves usability. For example, NASDAQ uses heat maps to show the NASDAQ-100 index volatility. Source: Wikipedia (http://en.wikipedia.org/wiki/Heat_map).

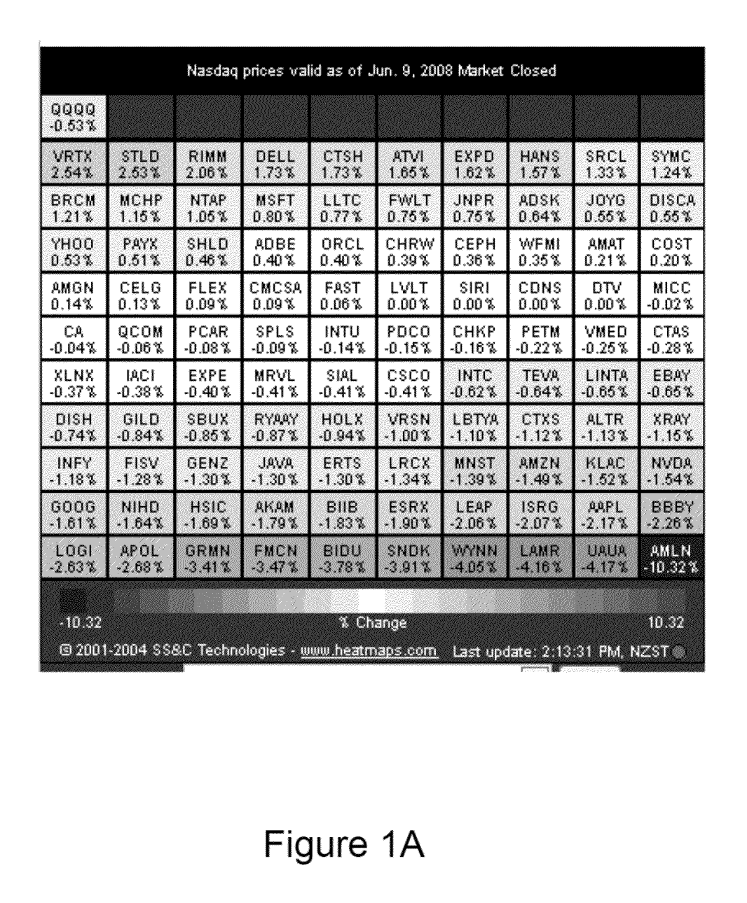

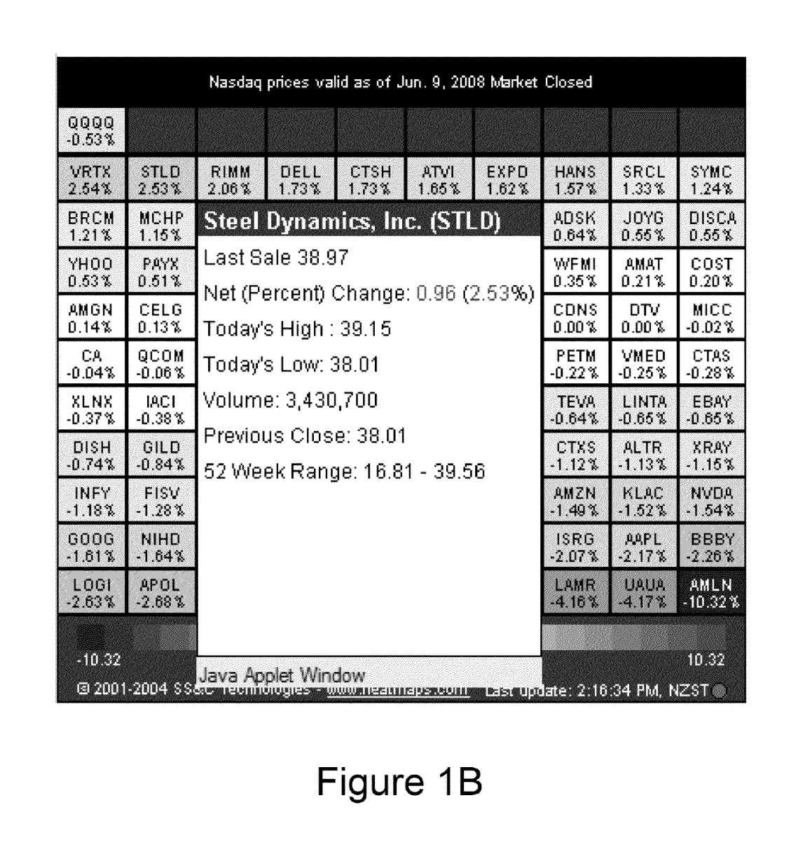

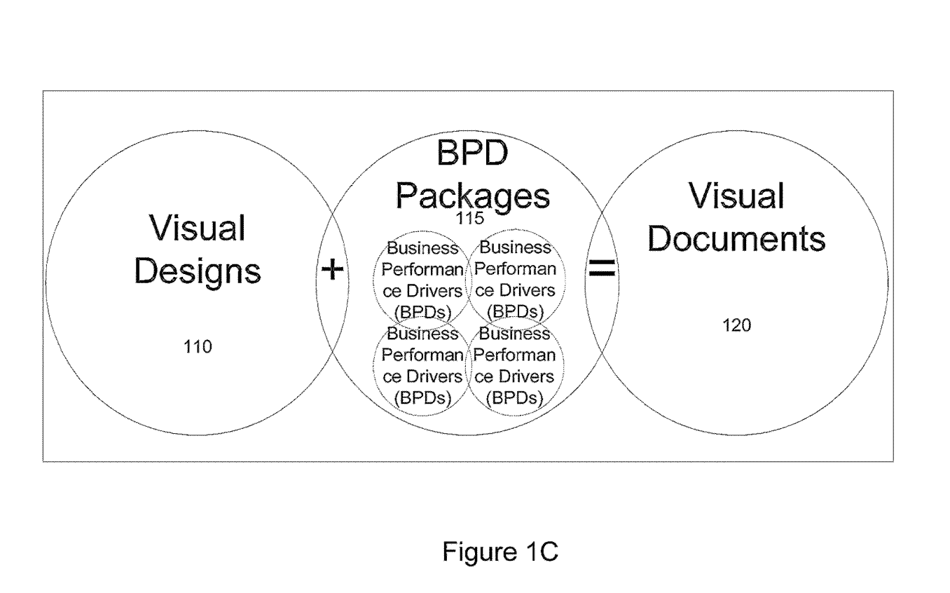

This is shown diagrammatically in FIG. 1A. Some blocks are colored green, which means the stock price is up and some blocks are colored red, which means the stock price is down. The blocks have a varying deepening of the relevant color to indicate the direction that the stock is moving. The deeper the color, the bigger the move.

If a user hovers over a stock, additional intra-day data is presented—as shown in FIG. 1B: Source: Nasdaq.com (Nasdaq-100 Dynamic Heatmap; Date Accessed, Jun. 10, 2008; http://screening.nasdaq.com/heatmaps/heatmap_{—}100.asp).

The key terms are set out diagrammatically in FIG. 1C. Visual designs 110 are individual visualization techniques. One or more are applied to visualize BPD packages 115 to create visual documents 120.

Many organizations are facing massive and increasing amounts of data to interpret, the need to make more complex decisions faster, and accordingly are turning to data visualization as a tool for transforming their data into a competitive advantage. This is particularly true for high-performance companies, but it also extends to any organization whose intellectual property exists in massive, growing data sets.

One objective of the described solution is to put experts' data visualization techniques in the customer's hands by skillfully guiding the end user through choosing the right parameters, to display the right data, and to create its most useful visualizations to improve business performance.

The described solution is a generic tool and can apply to multiple business areas that require decisions based on and understanding massive amounts of data. The resulting browser-based output is defined as a ‘Visual Document’.

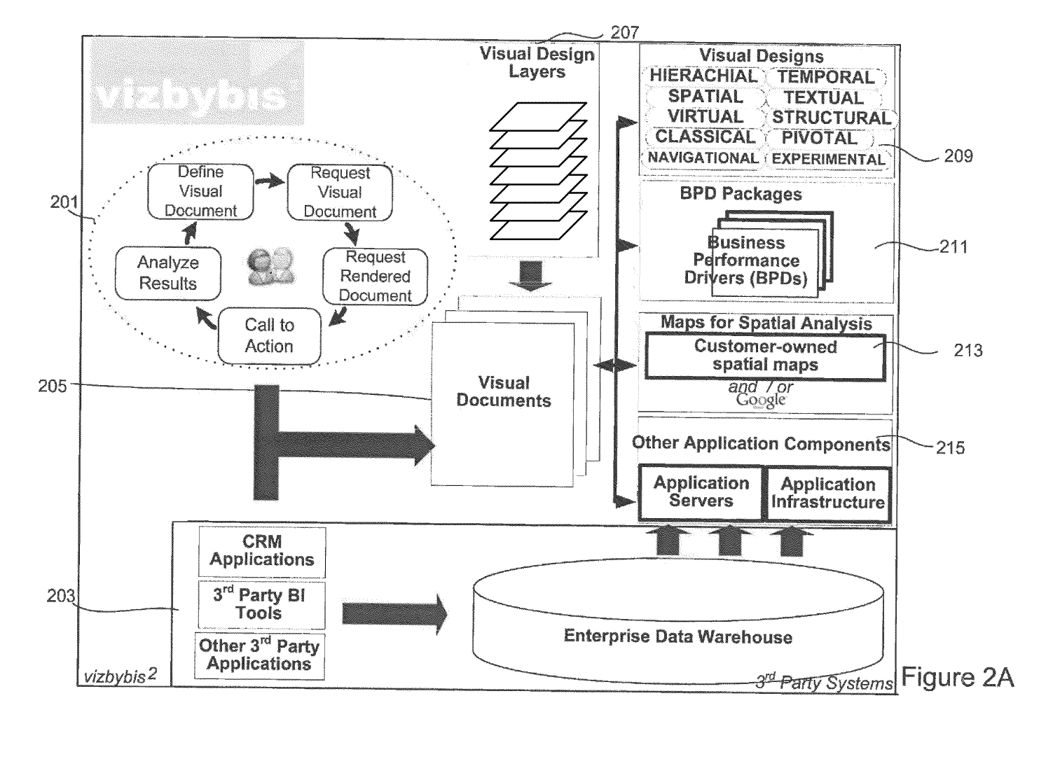

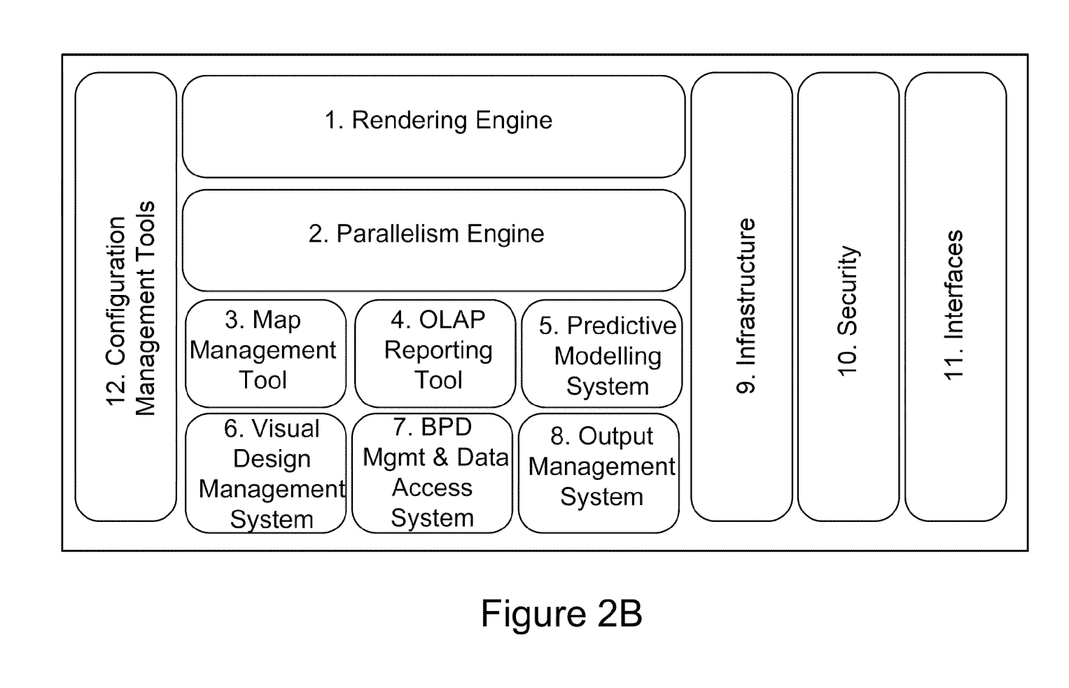

The solution provided is summarized in FIG. 2A.

The system identifies user tasks 201 in the form of defining visual documents, requesting visual documents, requesting rendered documents, calls to action, and analyzing results. These tasks are then detected by the system in conjunction with other systems 203, which include CRM applications, third party Business Intelligence (BI) Tools and other third party applications, all of which may access data stored in an enterprise data warehouse (EDW). The visual design layer concept 207 may be utilized within the visual documents 205. The creation of the visual documents is made in conjunction with a number of different defined visual design types 209, BPD packages 211, spatial analysis maps 213 and other application components 215, such as application servers and application infrastructure.

A Visual Document contains visual representations of data. Access to the data used to construct the visual representation is in many ways analogous to a textual document. It is constructed by applying Business Performance Driver(s) (BPD) data to a specific Visual Design (Visual Designs are grouped into ten classifications).

A Visual Document is designed to illustrate at least one specific point (using the visualization), support the points made with empirical evidence, and may be extended to provide recommendations based on the points made. The Visual Document is the actual deliverable from the software to the software user. Visual Documents may be stored, distributed or analyzed later, as needed.

The Visual Document is fed by data and a metadata database that stores definitions of BPDs—the BPDs are the focus of the Visual Document. A Business Performance Driver is a business metric used to quantify a business objective. Examples include, gross sales or units sold. For instance, the Visual Document may be used to graphically depict the relationship between several BPDs over time.

In the Visual Document, data is rendered in up to seven layers in one embodiment. However, it will be understood that the number of layers may be varied as needed by the user. Specific Visual Document Layers are described herein. However, it will be understood that further Visual Document Layers may be included over and above the specific types described.

Visual Designs are explicit techniques that facilitate analysis by quickly communicating sets of data (termed BPD Packages) related to BPDs. Once constructed, Visual Documents may be utilized to feed other systems within the enterprise (e.g., Customer Relationship Management (CRM) systems), or directly generate calls to action.

The described solution utilizes the best available technical underpinnings, tools, products and methods to actualize the availability of expert content.

At its foundation, the solution queries data from a high performance enterprise data warehouse characterized by parallel processing. This database can support both homogeneous (identical) and heterogeneous (differing but intersecting) databases. The system is adaptable for use with a plurality of third party database vendors.

A scalable advanced web server framework can be employed to provide the necessary services to run the application and deliver output over the web.

A flexible and controllable graphics rendering engine can be used to maximize the quality and speed levels required to support both static and dynamic (which could be, for example, animated GIF, AVI or MPEG) displays. All components can operate with a robust operating system platform and within secure network architecture.

Pre-existing (and readily available) third party components can be employed to manage user security (e.g. operating system security), industry specific applications and OLAP (Online Analytical Processing) or other more traditional reporting. The described solution is designed to facilitate speedy and reliable interfaces to these products.

A predictive modeling interface assists the user in analyzing forecasted outcomes and in ‘what if’ analysis.

Strict security, testing, change and version control, and documentation standards can govern the development methodology.

Many organizations are facing massive and increasing amounts of data to interpret, the need to make more complex decisions faster, and accordingly are turning to data visualization as a tool for transforming their data into a competitive advantage. This is particularly true for high-performance companies, but it also extends to any organization whose intellectual property exists in massive, growing data sets.

This clash of (a) more data, (b) the increased complexity of decisions and (c) the need for faster decisions was recently recognized in an IDC White Paper (Gantz, John et. al.; IDC White Paper; “Taming Information Chaos: A State-of-the-Art Report on the Use of Business Intelligence for Decision Making” November 2007), which described this clash as the “Perfect Storm” and that this ‘storm’ will drive companies to make a quantum leap in their use of and sophistication in analytics.

Today's business tools and the way they operate barely allow business users to cope with historical internal data, let alone internal real time, predictive, and external data.

Hence, a new paradigm in business intelligence solutions is required.

### System Overview

As explained above, FIG. 2A shows a high-level overview of the system.

There are five key components to the system. These are:

### 1. Visual Documents;

### 2. Visual Designs;

### 3. Business Performance Drivers (and BPD Packages);

### 4. Spatial Maps;

### 5. Application Components.

A description of each of these components is set out below under the respective headings.

### Visual Documents

The Visual Documents form the core of the solution from a user perspective. This may include visualization(s), associated data and/or metadata (typically the visual form) that the user defines requests and interacts with. The Visual Documents may consist of single frames or animated frames (which could be, for example, implemented in AVI, GIF or MPEG format or a sequence of still images).

The Visual Document is typically viewed in a dynamic web browser view. In this interactive view the user may observe, select and navigate around the document.

Once created, the Visual Documents may be stored in the database and may be distributed to key persons (printed, emailed etc.) or stored for later use and analysis.

### Visual Designs

The Visual Designs are a classification of the different types of visualizations that a user may choose. Within each Visual Design category, there are a number of visualizations. For example, the ‘spatial’ category can have retail store location maps, network maps or geographical location maps, such as, for example, maps available from Google™ or Yahoo™.

The described system allows users to select one or more visualizations (e.g. one visual form within a Visual Design category) to create a Visual Document.

There are ten Visual Design categories defined below, however it will be understood that further Visual Designs are envisaged, as well as the number of visualizations within each classification and the number of classifications.

### Business Performance Drivers (and BPD Packages)

Business Performance Drivers (BPDs) are a metric applied to data to indicate a meaningful measurement within a business area, process or result. BPDs may be absolute or relative in their form of measurement.

The Business Performance Driver (BPD) concept differs from the known KPI concept by introducing BPDs that

(1) may have multiple dimensions,
(2) place the BPD in the context of the factors used to calculate them,
(3) provide well understood points of reference or metadata around which visual document creation decisions can be made, and
(4) may contain one or more methods of normalization of data.

Common groups of BPDs are called BPD Packages. For example, BPDs relating to one industry (say, telecommunications) can be grouped into one BPD Package. BPDs may be classified into one or more BPD Packages. For example, Net Revenue with normalizations available of per customer or per month may be applicable in a number of industries and hence, applicable to a number of BPD Packages.

### Spatial Maps

Spatial maps allow for a user-owned and defined spatial map and/or for the user to use publicly available context maps such as Google™ Maps or Yahoo™ Maps. In either case, the user can display selected BPDs on the chosen spatial map.

Typically, a user-owned spatial map may be the inside floor space of a business and a publically available context map may be used for displaying BPDs on a geographic region e.g. a city, county, state, country or the world.

### Application Components

The described application includes two main components, the Application Servers and the Application Infrastructure.

The Application Server includes a number of servers (or server processes) that include the Rendering Engine (to make (or render) the Visual Documents), Metadata Servers (for the BPD Packages, the Visual Designs and the BPDs) and the Request Queue.

The Application Infrastructure is also comprised of a number of servers (or server processes) that may include a Listener (which ‘listens’ for document requests) and central error logging.

Based on the user selections made above (Visual Documents, Visual Designs and BPDs), the user can click on an action and send a communication to a third party system (CRM, Business Intelligence or other application). The third party system could, for example, load the list from the solution and then send out a personalized email to all members on that list.

According to one embodiment, the described server components of the application are a Java based application and utilize application framework such as the IBM™ WebSphere application server framework, other platforms and server applications may be utilized as alternatives. The client application may be a mashup that utilizes the server components or it could be a rich internet application written using the Adobe™ Flash framework.

Other key elements of the system may include:
Parallelism—Parallel processing to increase responsiveness or to increase workload scalability of queries or Visual Documents. This parallelism may also decrease response time for larger visual documents in particular animated images may be executed in a parallel fashion.
Security—System and user-access security. This security may be a combination of authorization and authentication. The security framework may be implemented using the application framework.
Map Updates—A map management tool to update user-owned spatial maps.
Predictive Modeling—This may be an interface to third-party predictive models.
Configuration Tools—The application may be supported by configuration tools to enable rapid deployment of the application.

### Modular Overview

### Module Descriptions

The diagram shown in FIG. 2B shows an overview of the software modules in the described system.

These modules are described in the subsequent table. More detailed descriptions and diagrams of each of the software modules are provided below.

The table below outlines the following four items in relation to each module:
1. Technology System Component: This is the name given to the system component; this name matches the name in the above diagram.
2. High Level Functional Description: Describes the role of the software module.
3. Caching: Indicates whether this module uses caching to optimize performance.

| Technology | | | |
|---|---|---|---|
| System | | | Cach- |
| Component | | High Level Functional Description | ing |
| 1. | Rendering | Produces images and animations; could use | Yes |
| | Engine | Google ™ Maps or Yahoo ™ Maps for | |
| | | spatial context map. | |
| | | The development of Special Layers enables | |
| | | Visual Document produced to have unique | |
| | | capabilities that were not previously readily | |
| | | available. | |
| 2. | Parallelism | Enables parallel execution of requests for | Yes |
| | Engine | high volume of Visual Document output and | |
| | | rapid results delivery to users. | |
| | | The preferred application framework selected | |
| | | is the IBM ™ WebSphere product. | |
| | | This framework enables the application to be | |
| | | scaled across multiple servers. | |
| 3. | Map | Provides key map editing features | Yes |
| | Management | (specifically CAD like) and map version | |
| | Tool | control (desktop and enterprise) tools. | |
| 4. | OLAP | Industry standard online analytical reporting. | Yes |
| | Reporting | For example, sorting, filtering, charting and | |
| | | multi-dimensional analysis. | |
| | | It is desirable that the user interaction with the | |
| | | data selection process in the data view is | |
| | | seamless with the data visualization view. For | |
| | | example, if the user selects 5 customers from | |
| | | the data view, the same 5 customers should be | |
| | | selected in the visualization view. This means | |
| | | that the solution may be a hybrid view (as | |
| | | discussed later). This hybrid view is a ‘simple’ | |
| | | view and is an interface to an industry leading | |
| | | OLAP tool. One option includes interfacing to | |
| | | the OLAP tool via a JDBC interface from the | |
| | | described solution or a web service model for | |
| | | the selection management. | |
| 5. | Predictive | An interface to external predictive modeling | Yes |
| | Modeling | engines; may also have some modeling | |
| | System | systems. For example, Self Organizing Maps | |
| | | (SOM). | |
| 6. | Visual | Tools for users to manage the different Visual | No |
| | Design | Designs. | |
| | Management | | |
| | System | | |
| 7. | BPD | Tools for users to manage the different BPD | No |
| | Management | Packages and their associated BPDs. | |
| | and Data | Contains Data Access capability that enables | |
| | Access | data to be queried from RDBMS (or | |
| | System | potentially other data sources). | |
| 8. | Output | For management of the documents (Visual | Yes |
| | Management | Documents) within the system. | |
| | System | | |
| 9. | Infra- | Core system management functions including | Yes |
| | structure | system logging and Request Queue | |
| | | management. The Request Queue is also | |
| | | described under parallelism and there may be | |
| | | crossover between these two module | |
| | | descriptions. | |
| 10. | Security | Enables access to the system (or parts thereof) | No |
| | | to be properly controlled and administered. | |
| 11. | Interfaces | Allows services to be called by (or to call) | No |
| | | external applications. | |
| 12. | Imple- | Tools to deploy and configure the software | Yes |
| | mentation | system. | |
| | Tools | | |

### Architectural Views of the System

This section contains descriptions and diagrams of the architectural views of the system. The architecture shows how the system components fit and operate together to create an operational system. If compared to a vehicle, the wiring diagrams, the physical body, the driving circle and key complex components like the engine would be shown in architectural views.

This view does not describe how the system is written; it describes the high-level architectural considerations.

Architectural considerations are typically implemented by one or more software modules. The modular view described herein lays out a high-level view of how the software modules are arranged.

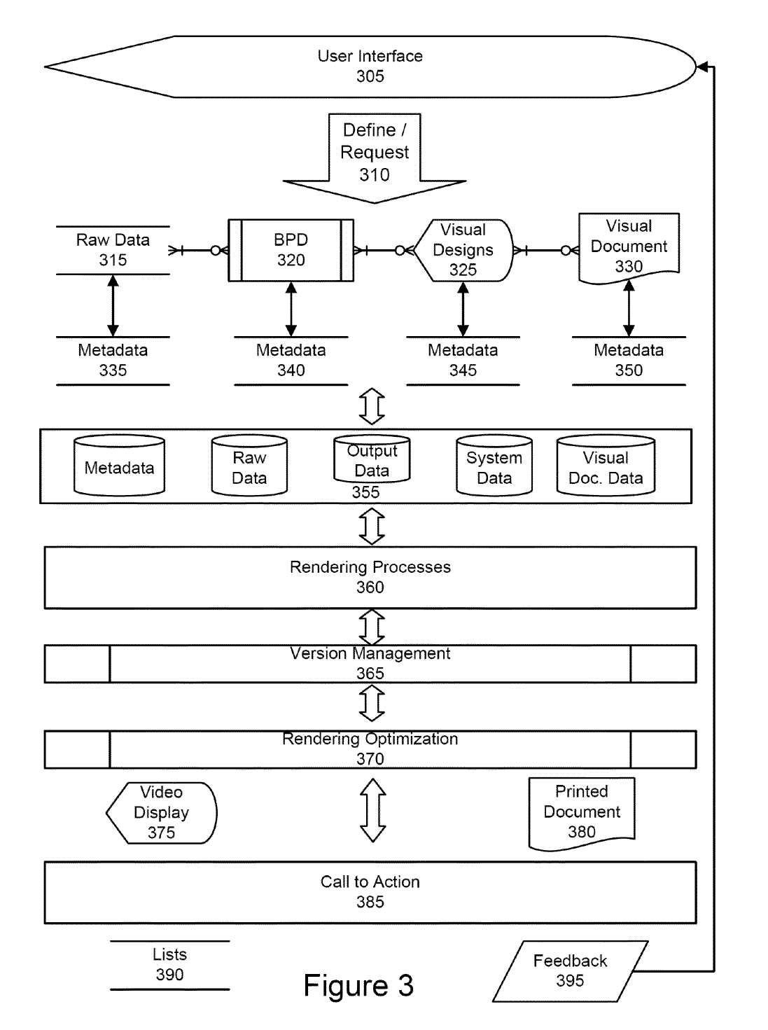

FIG. 3 shows a general overview of the data flow within the system.

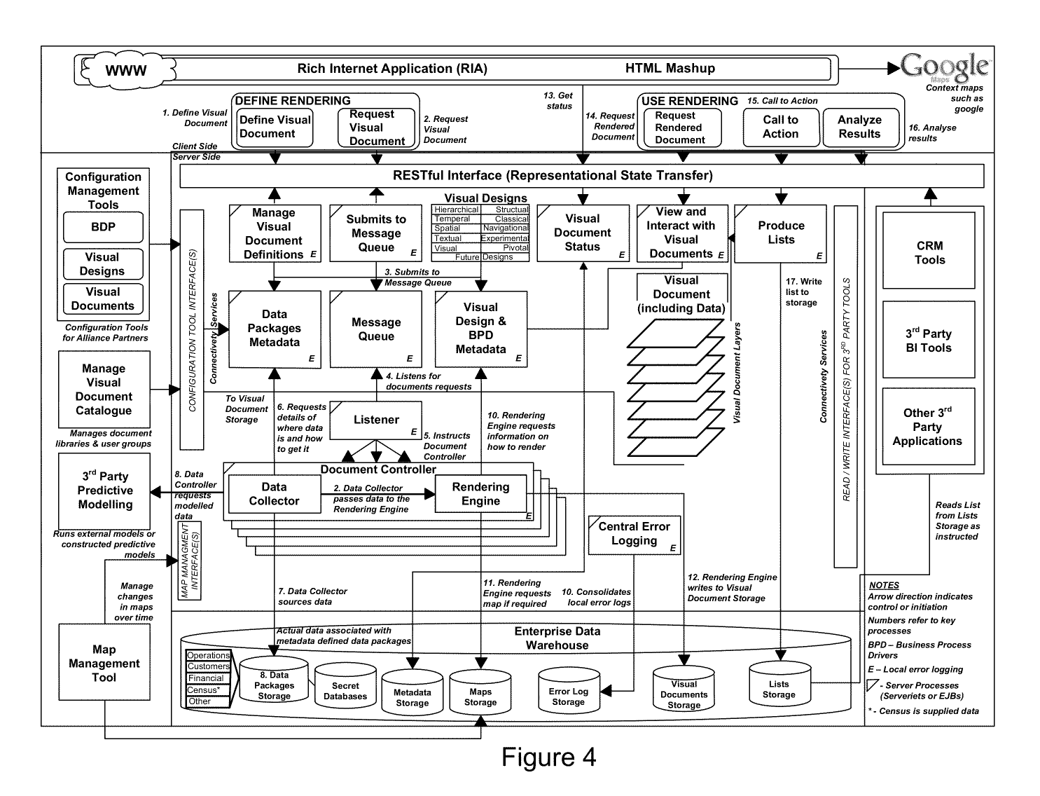

FIG. 4 shows the architectural overview of the described solution. This diagram is elaborated by the diagrams and descriptions in following sections of this document.

The following modules or components are shown:

Web interface Module 4105: User interfaces are browser based or may be a web services client, a rich internet application or may be a thick client. In all cases the user interface uses the same interface to the back end services.
Rendering Definition Module 4110: The user interface is used to define and request the rendering of Visual Documents
Rendering Use Module 4115: Visual Documents are used for analysis, and precipitate calls to action.
Connectivity Services Module 4120: The definition and rendering of Visual Documents is performed through a set of programs or services called the Connectivity Services.
Configuration Management Tools Module 4125: Multiple versions of the basic elements; BPD, Visual Design, Visual Documents; are managed by a set of programs called the Configuration Management Tools.
Visual Document Management Catalog 4130: One such Configuration Management Tool (4125) is a set of programs that manage a users' catalog of available Visual Documents.
Predictive Modeling Module 4135: Predictive modeling is used for forecasting unknown data elements. These forecasts are used to predict future events and provide estimates for missing data.
Map Management Tool 4140: Another of the Configuration Management Tools (21125) is the Map Management Tool. It is designed to manage versions of the spatial elements of a visual design such as a geographic map or floor plan.
Visual Document Definitions Management Module 4145: Visual Document Definitions are managed through the use of metadata (4175).
Message Queue Submission Module 4150: Requests for Visual Documents are handled through queued messages sent between and within processes.
Visual Design Type Module 4155: Visual Documents are comprised of one or many Visual Designs in these categories.
Visual Document Status Module 4160: The status of Visual Documents is discerned from the metadata and displayed on the user interface.
Interaction and Visual Document View Module 4165: The user interacts with the Visual Documents through the user interface, and appropriate changes to and requests to read are made to the metadata.
List Production Module 4170: Where additional output such as customer lists are required, they are requested using the user interface and stored in the EDW (4215).
Data Packages Metadata Module 4175: Metadata is used to describe and process raw data (data packages).
Message Queue Module 4180: Messages may be queued while awaiting processing (4150).
Visual Design and BPD Metadata Module 4185: Metadata is used to describe and process the BPD's and Visual Designs associated with a particular Visual Document.
Visual Documents Module 4190: Visual Documents may be comprised of layered Visual Designs.
Third Party Modules 4195: Visual Documents may be used with or interact with other third party tools.
Listener Module 4200: The listener processes messages (4150) in the message queue (4180)
Document Controller Module 4205: The document controller is used to provide processed data to the rendering or query engines.
Central Error Logging Module 4210: System errors are detected and logged in the EWP (4215).
EDW 4215: All data is typically stored on a database, typically, multiple fault tolerant processors in an Enterprise Data Warehouse.

The following architectural components are described in more detail.

| Architectural | |
|---|---|
| Component | Description |
| Connectivity | This is a common communication service that is used |
| Services | when sending messages between systems (i.e. the |
| | described solution and 3^{rd} party tools) and between the |
| | described application layer and the user interface layer. |
| Configuration | Allows specialized users to configure Visual Designs and |
| Management | Visual Documents to their needs - which differ from the |
| Tools | default configuration provided. |
| Manage Visual | Gives selected users the ability to search, sort, group, and |
| Document | delete Visual Documents in the Visual Document |
| Catalog | Catalog. |
| Predictive | External modeling systems that use data sent from the |
| Modeling | described solution to perform complex calculations to |
| | produce predictive data. This predicted data is piped |
| | through the described solution to the user. |
| Map | This is an application that enables users to create modify |
| Management | and delete individual maps to manage the complete |
| Tool | sequences, this is very appropriate for management of |
| | floor plans. |
| Data | The services responsible for providing metadata that |
| Packages | enables the requester (typically, Data Collector) to source |
| Metadata | the data for the BPD. |
| Visual | The services responsible for providing the metadata |
| Design & | to the requester (typically the Rendering Engine) |
| BPD Metadata | that enables the construction of the Visual Documents. |
| Request | The Request Queue manages the communication of |
| Queue | requests for rendering of Visual Documents. These |
| | communications may be scheduled. |
| Document | The Document Controller consists of two components. |
| Controller | The first is the Data Collector responsible for reading the |
| | appropriate metadata and retrieving the data from the |
| | EDW (Enterprise Data Warehouse). This data is passed |
| | to the Rendering Engine that is responsible for producing |
| | the Visual Document. Document Controllers run parallel |
| | Visual Document requests, build and store documents. |
| Read/Write | The described solution provides a common interface for |
| Interface for 3^{rd} | 3^{rd} party tools to communicate with e.g. CRM |
| Party Tools | applications. |
| 3^{rd} Party | One of the 3^{rd} party tools that the described solution may |
| BI Tools | integrate with is an external OLAP tool. |
| Secret | Secret databases are a method of sharing encrypted |
| Databases | databases and providing a SQL interface that enables end |
| | users to run queries against atomic data without |
| | discovering the details of the data. |

The following terms have been also been used in FIG. 4. These are explained in more detail below.

| Architectural | |
|---|---|
| Component | Description |
| Logging | Logging (for example, error logging and access |
| | logging) is an inherently difficult activity in a |
| | parallel independent and predominantly stateless |
| | system. |
| | The main issue that arises is that logging presents |
| | potential links between systems and therefore |
| | dependencies. |
| | Typically within the application, each server will be |
| | responsible for its own logging. This ensures that the |
| | system scales without degradation in performance. |
| | A separate process (central log reader) may be used |
| | to consolidate these logs dynamically as and when |
| | required. |
| Web Server | Web Servers respond to requests from users to |
| | provide Visual Documents. They read any required |
| | information from the metadata servers and Visual |
| | Document storage servers. If necessary they write |
| | Visual Document requests to the Request Queue. |
| Metadata | Metadata servers are responsible for storage and |
| Servers/Storage | user views of metadata. The metadata servers are |
| | also responsible for the validation of user rights to |
| | read Visual Documents (within the application). |
| Visual Document | The Visual Document Catalog is a secure storage for |
| Storage | all Visual Documents. Access is only possible when |
| | security requirements are met. |
| Data Collector | Typically the data collector queries the customer's |
| | data warehouse. The data warehouse can be |
| | augmented with additional subscribed |
| | embellishment data. This will provide the raw data |
| | that is represented visually back to the user. |
| BPD Packages | The described solution will use metadata to define |
| Metadata | groups of BPDs. These groups of BPDs are called |
| | BPD Packages. BPD Packages enable both internal |
| | data measures to be efficiently installed and external |
| | datasets to be provided. |
| | BPD packages contain no data. |

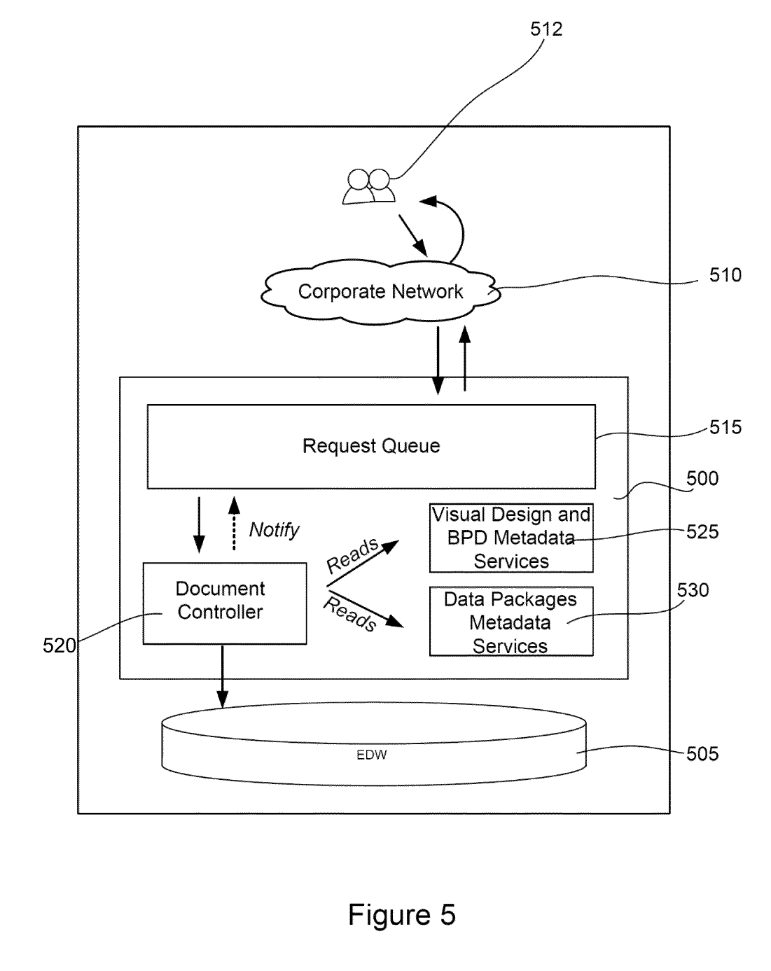

A further high-level system delivery overview of the solution is set out as shown in FIG. 5.

The described solution 500 is hosted by the enterprise 510. The figure shows the logical flow from the submission of a request to the end result, viewing the rendered Visual Document.

The data being visualized belongs to the customer 512 and the submitted request is unknown to the entity running the visualization system 500.

The controlling entity, integrators and customers may wish to have summaries of technical performance data (usage patterns, errors etc) sent from the operational system back to the integrator or controlling entity.

The system 500 has access to the data in a EDW 505. The system utilizes a request queue 515 to control requests from a corporate network 510. These requests are forwarded to a document controller 520. The document controller 520 accesses both the EDW 505 and reads visual designs and BPD metadata services 525, as well as data packages metadata services 530.

The system described thus enables various methods to be performed. For example, data is transformed into visually interpretable information. The visually interpretable information is in the form of visual representations that are placed within one or more visual documents.

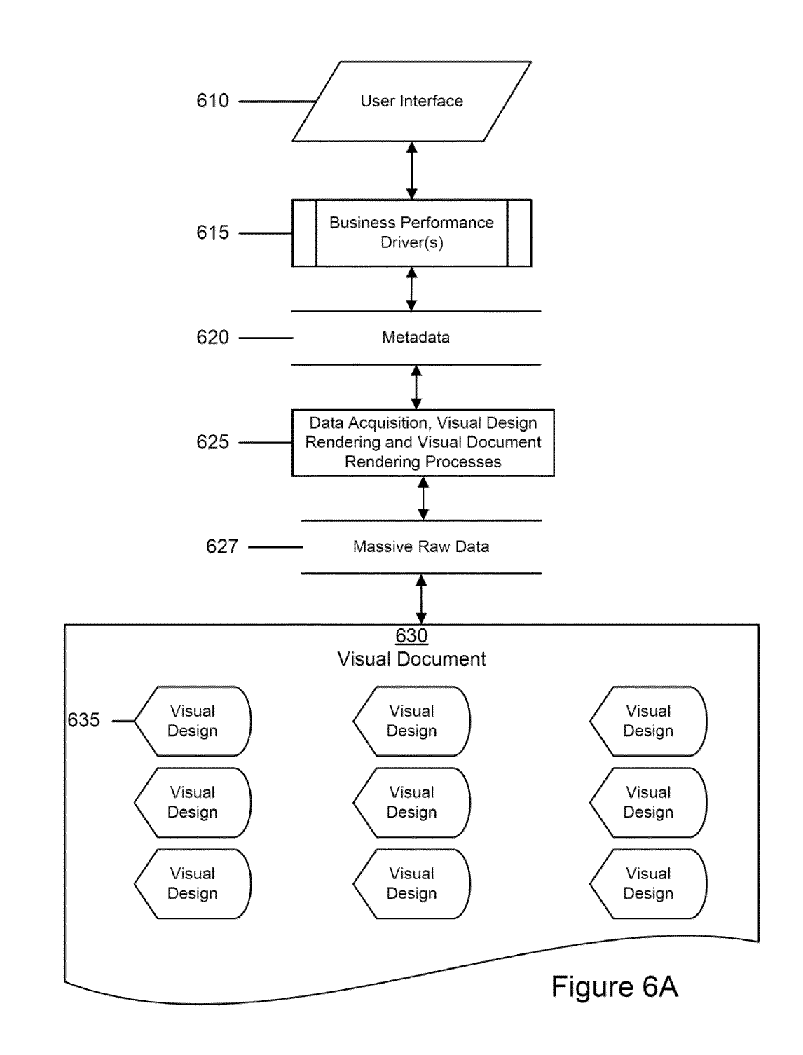

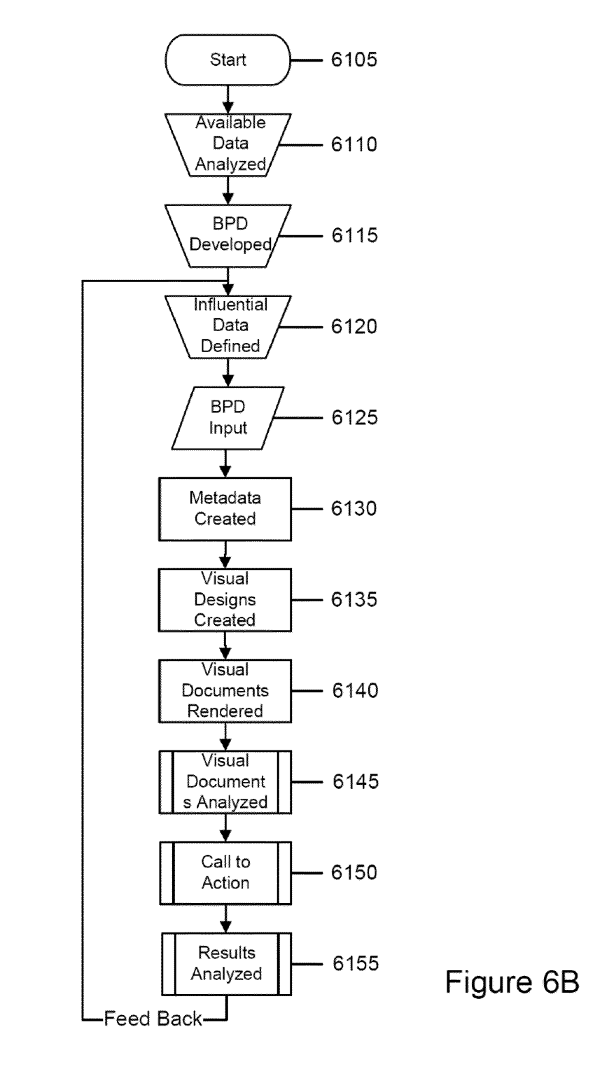

FIG. 6A shows a general data flow diagram for the described system.

The User Interface 610 allows the user to define BPD's 615 in terms of raw data 627, which become the focus of the Visual Document 630.

Further, the User Interface 610 allows the user, through automated expert help, to create the Metadata 620, the most appropriate Visual Designs 635 that make up the Visual Document 625 in order to provide detailed analysis of data related to the BPD 615. The data acquisition, visual design rendering and visual document rendering processes utilize massive amounts of raw data 627.

The Metadata 620 is used by the Processes 625 to optimize the acquisition of the appropriate Data 627, processing of the data into useful information, and to optimize the creation and rendering of the Visual Designs 635 and the Visual Document 630 that contains them.

This method includes the steps of providing comprehensive yet easy to understand instructions to an end user that has accessed the system and the visual design application. The instructions assist the end user in obtaining data associated with a theme, wherein the theme may be focused on objectives that have been derived from the data. The objectives may be business objectives, for example. In this way, the system guides a user carefully through the many choices that are available to them in creating the visual representations, and the system automatically tailors its instructions according to not only what the user requires, but also according to the data that is to be represented. The system focuses on providing instructions to enable a visual representation to be created that will enable an end user to more effectively understand the data that has been collated.

Further, the instructions assist the end user in determining one or more summaries of the obtained data that enable the end user to understand the theme, as well as organizing the determined summaries into one or more contextual representations that contribute to the end user's understanding of the theme.

Further, instructions are provided that assist an end user in constructing one or more graphical representations of the data, where each graphical representation is of a predefined type, as discussed in more detail below, and includes multiple layers of elements that contribute to the end user's understanding of the theme.

Finally, instructions are provided to assist an end user in arranging the produced multiple graphical representations in a manner that enables the end user to understand and focus on the theme being represented as well as to display or print the organized graphical representations. The system assists in the organization or arrangement of the representations, elements thereof, within the visual document so as to ensure certain criteria are met, such as, for example, providing a suitable representation in the space available, using the minimum amount or volume of ink to create the representation, and providing a suitable representation that depicts the theme in a succinct manner, or visually simplistic manner.

The data being processed to create the graphical representations may be particularly relevant to the theme being displayed, disparate information or indeed a combination of relevant and disparate information.

There are multiple types of graphical representations that may be included within the visual document. The types are discussed in more detail below and include a hierarchical type, a spatial type, a virtual type, a classical type, a navigational type, a temporal type, a textual type, a structural type, a pivotal type, and an interactive type.

Further, the instructions may assist an end user in arranging the graphical representations in order to display high density data in a manner that conveys important information about the data, rather than swamping the end user with multiple representations that look impressive but do not convey much information.

In addition instructions may be provided to assist the end user in arranging the graphical representations to allow supplementary information to be added, where the supplementary information may be provided in any suitable form. Particular examples provided below depict the supplementary information being provided in subsequent visual layers that overlay the graphical representation. Alternatively, or in addition, supplementary information may include additional elements to be displayed within a single layer of the representation, for example, in the form of widgets.

FIG. 6B shows a flow diagram according to this embodiment of the invention.

Step 6105: Process Starts. User decides to manage the business.
Step 6110: Available data is identified and analyzed.
Step 6115: Business Process Drivers (metrics defined in terms of the data to indicate a meaningful measurement within a business area, process or result).
Step 6120: Data influencing the BPD metrics are identified.
Step 6125: BPD's are input into a computer system
Step 6130: BPD is categorized and appropriate metadata describing it is generated.
Step 6135: Visual Designs to display the influential data are created.
Step 6140: Visual Designs are aggregated into Visual Documents and rendered. Adjustments are made based on the freshness of all components (e.g., BPD, available data).
Step 6145: Visual documents are analyzed by the end user.
Step 6150: The end user decides on and implements actions based on the analysis in 6145.

As touched on above, business performance drivers (BPDs) are used to enable more efficient data analysis so as to produce accurate and relevant visual representations of the data. A BPD is a form of advanced business measure wherein additional information is included within the BPD that enables the system using the BPD to understand how to manipulate the BPD. That is, one or more intelligent attributes are included with the business measure to form the BPD, where those attributes reference or include information on how the BPD is to be processed or displayed. The form of processing and display may also be varied according to the device type or media upon which the business measures are to be displayed.

The attributes are attached to the business measure by storing the BPD in the form of a mark up language, such as, for example, HTML or XML. It will however be understood that any other suitable format for storing the BPD may be used where the attributes can be linked to the business measure.

In the example of HTML, the attribute is included as a tag. One such example would be to include the data or business measure within the body of the HTML code and follow the business measure with a tag that references the attributes, or dimensions, associated with that business measure.

Further, the attributes may also be modified or deleted, or indeed new attributes added, during or after the processing of the BPD so that the attributes are maintained, or kept up to date, bearing in mind the requirements of the entity using the BPD to visualize their data.

The business performance drivers, or measurable business objectives, are identified in order to create graphical representations of the business objectives, where those representations are placed within a visual document. A business objective may be, for example, a metric associated with a business.

Instructions are provided by the system to the end user, in order to assist the end user in establishing multiple business objectives as functions of available metrics, as well as assisting the user in organizing the business objectives into a contextual form that contributes to the end users understanding of the business objectives.

Further, instructions are provided to assist the end user in constructing one or more graphical representations of the business objectives, where each graphical representation is of a predefined type, as mentioned above and described in more detail below. Further, each graphical representation includes multiple layers of elements that contribute to the end user's understanding of the business objective.

The elements within the graphical representation may include, for example, a shape, position, color, size, or animation of a particular object.

Instructions are also provided by the system to assist the user in arranging multiple graphical representations in a suitable manner that enables the end user to understand and focus on the business objectives being represented.

Finally, the end user is also assisted with instructions on how to display the organized graphical representations.

The following section describes a method of creating a visual representation of data in the form of a visual design.

The method includes the steps of the system providing instructions to an end user to assist the end user in constructing multiple graphical representations of data, where each graphical representation is one of a predefined type, as defined above and explained in more detail below, and the graphical representation includes multiple layers of elements that contribute to the end user's understanding of the data

The system also provides instructions to an end user that assist the end user with arranging multiple graphical representations of different types within the visual representation in a manner that enables the end user to understand and focus on the data being represented, as well as providing instructions to assist the end user in displaying the visual representation in a suitable manner.

The visual representation may be displayed in a number of different ways, such as on a color video screen or a printed page. The information that is forwarded to the display device to create the visual representation may differ according the type of display device so that the visual representation is produced in the best known suitable manner utilizing the advantages of the display device, and avoiding any disadvantages.

The data being displayed may be based on a measured metric or an underlying factor that affects a metric.

The elements within the graphical representation may include a shape, position, color, size or animation of a particular object.

Although a single visual document may include only one type of graphical representation, either in the form of multiple graphical representations or a single representation, there will also be situations where multiple types of graphical representations may be organized within a single visual document in order to convey different aspects of the data, such as, for example, temporal as well as spatial information. The inclusion of different types of graphical representations within a single document can provide an end user with a better understanding of the data being visualized.

Further, the single visual representation may be arranged to be displayed as an image on a single page or screen. This may be particularly useful where space is at a premium yet the user requires the visual representation to be provided in a succinct manner. For example, the user may request certain information to be displayed in a visual representation on a single mobile telephone display, or a single screen of a computer display, in order to show a customer or colleague the results of a particular analysis without the need to flick between multiple screens which can result in confusion, a waste of energy and ultimately a loss of understanding of the visual representations.

The same issue applies to printed representations, where the result of the system enabling a user to arrange a single representation, which may include multiple elements or layers, on a single page not only succinctly represents the data being analyzed but also saves the amount of paper being printed on and the amount of ink being used to print the document.

Further, the amount of ink required for a visual representation may be further reduced by providing instructions to the end user in a manner that directs them to control and use white space in a representation in an efficient manner so as to reduce the requirement of ink.

Multiple types of graphical representations may be merged together within a single visual document, or representation.

As mentioned above, instructions can be provided by the system to assist the end user in adding supplementary information to the visual representation, and the supplementary information may be provided in layers within the representation.

### Visualization Framework

The following description provides the visualization framework that will support embodiments of the present invention. The description includes an overview of the importance of Visual Design including a brief historical recount of a world-recognized leading visualization. The description also sets out the Visual Design classifications for the described solution.

It will be understood that the Visual Design examples described in this section are examples for illustrative purposes to identify the concepts behind how the visualization is produced. Therefore, it will further be understood that the concepts described can produce visual designs different to those specifically described. The Visual Design examples shown are also used to help the reader understand the narrative describing the Visual Designs.

The system described is specifically adapted to create actual specific visualization designs relevant to selected vertical and horizontal industry applications being deployed.

A vertical industry application is one that is associated with a solution directed at a specific industry, such as, for example, the entertainment industry. In this example, BPDs relevant to that industry are created, such as rental patterns of movies over different seasons.

A horizontal industry application is one that is associated with solutions across multiple industries. For example, the BPD may be based on CRM analytics, which applies across a whole range of different industries.

Design is now a fundamental part of almost every aspect of how people live work and breath. Everything is designed from a toothbrush to every aspect of a web site. Compare visual design to architectural design—in both cases anybody can draw quite complex pictures. The resulting pictures could have stimulating and well drawn graphic elements. In both cases, the question is why does the world need designers? Exploring this question more deeply one can ask—does it make such a difference to how one perceives and understands a design when it is made by a professional rather than an amateur?

The trend in business intelligence is to design tools to provide flexibility and leave the world of visual design to the amateurs. Stephen Few comments in Information Dashboard Design (Few, Stephen—from white paper “BizViz: The Power of Visual Business Intelligence”—Mar. 7, 2006. www.perceptualedge.com) that “Without a doubt I owe the greatest debt of gratitude to the many software vendors who have done so much to make this book necessary by failing to address or even contemplate the visual design needs of dashboards. Their kind disregard for visual design has given me focus, ignited my passion, and guaranteed my livelihood for years to come.”

Visual Designs within the described framework are well thought through in how the data is displayed. The described system allows good information visualization design concepts to be captured and delivered back to users as Visual Documents using unique data processing and analysis techniques.

### Visual Designs

### Method or Visual Design Classifications

According to this embodiment, ten Visual Design types are defined and incorporated into the described system. It will be understood that additional Visual Designs may be further defined including the creation of certain examples and actual Visual Designs for specific industry applications.

The visual design types include:
Hierarchical
Temporal
Spatial
Textual
Virtual
Structural
Classical
Pivotal
Navigational
Interactive

The following describes a method for the assessment of Visual Design quality. In assessing the quality of a Visual Design the following factors should be considered:
Alternative approaches—To assess the capability of a Visual Design it is important to contrast it with other visualization methods. In particular one should compare the visual design to a classical graph or table of numbers. This comparison is important as many data visualizations add considerable graphic weight but little informational value.
Visual simplicity—Looking at a visualization should not overload the mind. The simplicity of the visualization is important as it enhances interpretation and allows common understanding without training. Some visualizations require considerable training to be applied. In general, the described solution will not use these visual designs.
Data density—the density of data in a visualization is a critical measure of its overall value. Higher density visualizations, if successful in maintaining their simplicity, have considerable potential to increase the flow of information to end users.
Volume of ink used—Is the visual design using negative space to show key information? This use of negative space allows lower volumes of ink to be used while showing the same or higher density of information. In addition, ink required is generally reduced as the number of “views” or pages of data is reduced to convey the same volume of data.
Capability to be illuminated with detail—In the end, data visualization becomes information visualization when the specific details are shown. The ability of a visualization to hold detailed information in specific places, often achieved with labels, is a key element in determining its value as an information visualization.

### Visual Design Layers

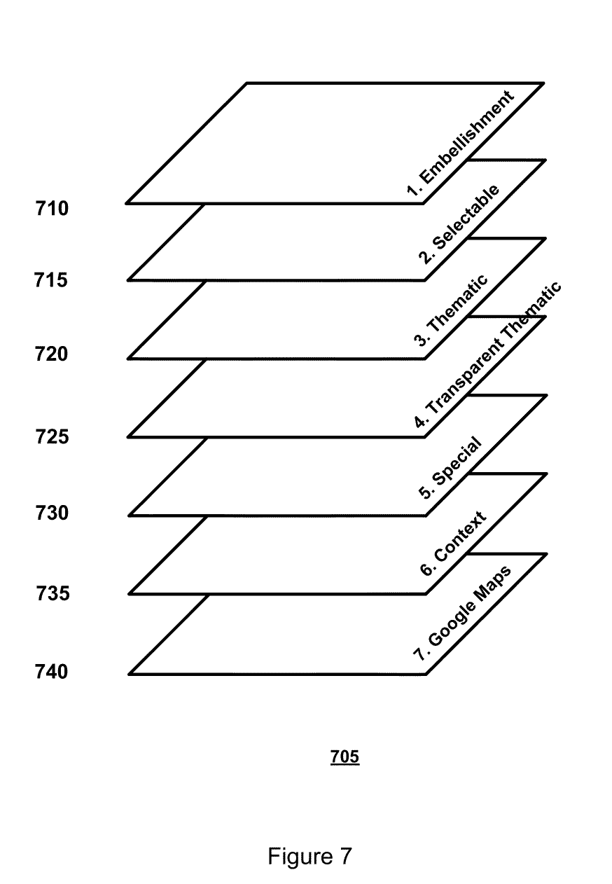

There are seven defined Visual Design Layers which are set out diagrammatically as shown in FIG. 7. Other visual design layers may be added as appropriate.

These seven Visual Design Layers are described in the following table:

| | Visual | |
|---|---|---|
| | Design | |
| | Layer Type | Description |
| 1. | Embel- | Embellishment Layers have labels, symbology |
| | lishment | and/or other detailed information that is used to |
| | Layers | illuminate information that is displayed in the lower |
| | | layers. The overlay can also include controls such |
| | | as progress bars or spark-lines. |
| 2. | Selectable | Selectable Layers are interactive and consist of |
| | Layers | items that can have associated data. On a retail |
| | | spatial map it includes store locations as they have |
| | | associated data. Selectable Layers are typically not |
| | | obscured by thematic treatments. |
| 3. | Thematic | Thematic Layers overlay colors or heatmaps on |
| | Layers | Special Layers. These thematic treatments become |
| | | the core visual impact of the final Visual |
| | | Document. |
| 4. | Transparent | Transparent Thematic Layers are very similar to |
| | Thematic | Thematic Layers (in fact are an alternative). The |
| | Layers | only difference is that they are graphically merged |
| | | using a transparent overlay. For example, this kind |
| | | of layer is necessary to overlay heatmaps on |
| | | maps.google.com. |
| 5. | Special | Special Layers construct the structure of the data. |
| | Layers | Specifically the Special Layer understands how to |
| | | automatically draw the data so that other thematic |
| | | treatments can be applied. Special Layers include |
| | | mundane layers such as layers of polygons. |
| 6. | Context | These are the lowest level of the visualization; they |
| | Layers | include background maps and other contextual |
| | | information. |
| 7. | Context Map | This is a type of context layer that is rendered from |
| | Layers | a map such as Google ™ Maps, Yahoo ™ Maps etc. |
| | | This may be a road map, satellite map or any other |
| | | map. It is past as a set of tiled images and as such |
| | | can only be used as a Context Layer. Typically, a |
| | | Transparent Thematic Layer will be used to display |
| | | thematic data on a context map layer. |

In terms of the Special Layer, two examples of Special Layers are set out below:

### A. Classic Example of Special Layer: Voronoi Diagram

Source: Wikipedia (http://en.wikipedia.org/wikiNoronoi_diagram)

In mathematics, a Voronoi diagram, named after Georgy Voronoi, also called a Voronoi tessellation, a Voronoi decomposition, or a Dirichlet tessellation (after Lejeune Dirichlet), is a special kind of decomposition of a metric space determined by distances to a specified discrete set of objects in the space, e.g., by a discrete set of points.

In the simplest and most common case, in the plane, a given set of points S, and the Voronoi diagram for S is the partition of the plane which associates a region V(p) with each point p from S in such a way that all points in V(p) are closer to p than to any other point in S.

A Voronoi diagram can thus be defined as a Special Layer, where a set of polygons are generated from a set of points. The resulting polygon layer can then be subjected to thematic treatments, such as coloring.

### B. Non Traditional Example of a Special Layer: Calendar

A calendar can be generated as a Special Layer for display of a temporal visual document. This Special Layer would require a ‘start date’ and an ‘end date’, most other information regarding the nature and structure of the Calendar could be determined automatically. The thematic layers would then use the structure of the calendar as a basis for thematic treatments such as coloring and contouring.

In an example from ENTROPÍA (ENTROPÍA; “Más tiempo”; http://www.luispabon.com/entropia/index.php?entry=entry071129-145959) a calendar is shown that can be created into a spiral. The structure and layout of this spiral will be the subject of considerable design discussions by information designers focused on issues such as aesthetics and clarity of information. The result of this discussion is a visual design of a spiral calendar Special Layer. This Special Layer can then be used for thematic treatments such as coloring.

As touched on in the background discussion, it would be beneficial to review, analyze and/or represent data based on the purpose of a query.

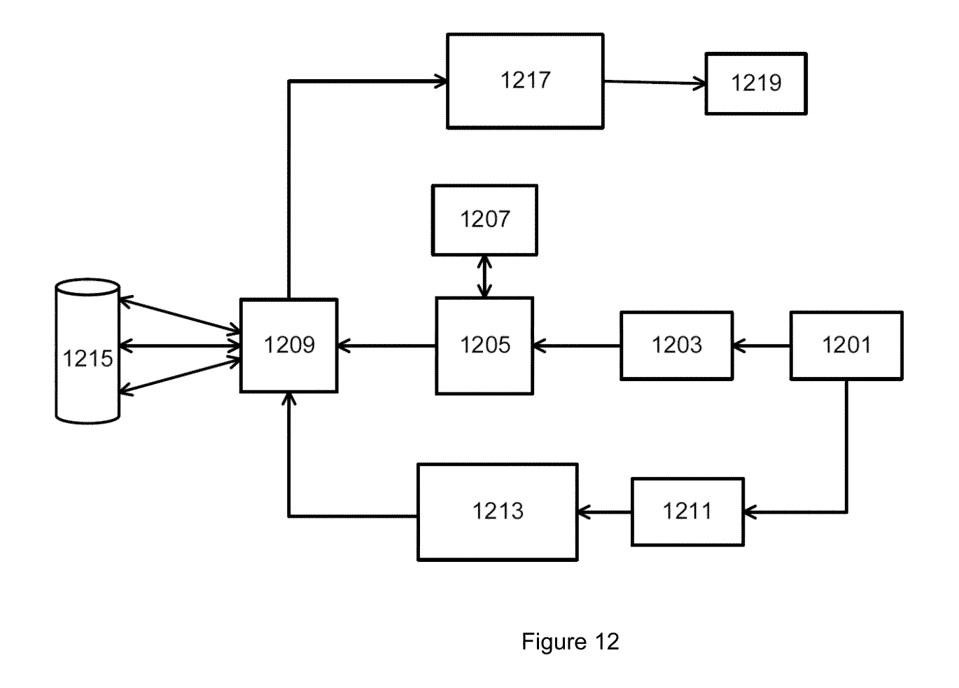

Referring to FIG. 12, an example of a system in the form of a block diagram is provided. A user interface 1201 provides an interface between a user and the herein described system. The user enters a request for data via this interface, such as via a desktop keyboard and screen, for example.

A set of data interface objects 1203 are generated by the herein described system based on the user's request. A data interface object is an object that provides an interface between a user and the underlying data. For example, data interface objects include BPD's and Dimensions.

A data interface object builder 1205 generates the data interface objects based on a set of rules contained and implemented by a rules engine 1207. That is, the builder 1205 operates in accordance with the rules of the rules engine.

A query builder 1209 receives the generated data interface objects from the builder 1205 to generate queries based on instructions received from a perspective generator 1213. The perspective generator receives input data from a perspective request module 1211 that receives instructions from the user interface 1201.

The query builder develops the relevant queries and accesses the appropriate or required data from a data store 1215. The results are then transferred to a visualization document output module which generates the visualization document. The resultant document is then provided to an output module 1219, such as a display, printer or further storage module.

Various different perspectives can be generated by the perspective generator 1213 without having to rework all of the data interface objects, thus providing a dynamic system. For example, the different perspectives may include the following:

A first perspective wherein a change in state of whatever is being analyzed may be considered irrelevant to the user's data requirements. For example, a recorded change in location within the data may not be considered relevant to the user's requested perspective of the data. Therefore, the only requirement is access a view of the available data for a defined time period regardless of the state or condition of the item or entity being analyzed. One example would be a financial view of a company as it has moved through various different location changes (another example could be restructuring of a company). When analyzing the financial data for that company for a defined time period, the actual state (e.g. location or structure) of the company at the time may not be considered relevant to a financial analyst. That is, the analyst may only want to see the true financial perspective.

A second perspective wherein a last known state of what is being analyzed is relevant and only the transaction data associated with that last state is retrieved and analyzed for this perspective. For example, a change in location for a set of data may be considered particularly relevant as the analyst only wants to see how that data is reacting to that location.

Third perspective wherein a change in state of whatever is being analyzed may be considered irrelevant to the user's data requirements as in the first perspective, but in this case the data for the time period being analyzed is considered to be relevant for the attribute of the dimensions of the data set as it was at the end time point of the analysis. For example, financial data for a company located in three different locations is used to determine the likely financial state of that company in its current location. That is, the earlier financial data for different locations is considered relevant for the purposes of the current state of the company, even though the location has changed. In terms of a gaming device for example, for marketing program analysis it is important to know how a device has performed in a number of different locations to get an understanding of how it may perform in its current location. Merely ignoring all previous locations for that device may corrupt the data analysis.

For example, the query may specifically relate to data obtained from:
a defined location
a defined time or time period
a defined customer or group of customers
a defined machine or group of machines
a defined configuration
a defined theme

Each query has specific attributes associated with it. These attributes define the purpose of the query. For example, for different purpose's different time periods may need to be analysed, e.g. what time period must be analysed to satisfy the purpose of the query?

Database queries are generated according to this invention in order to produce multiple perspective query results.

The present application is focussed on a query builder (i.e. an SQL generator) that is used to query a database. A mechanism is provided that enables the query builder to understand a pre-defined set of different perspectives and to generate these multiple perspectives from the query provided.

A single query is generated using standard SQL techniques based on the requirements of the analytical perspective. The query generated is not represented in standard SQL but is based on a set of rules that is then used to build the SQL.

The system then generates a set of multiple pre-defined perspectives from the single query.

The system does not carry out location or machine based analysis but instead performs business type analysis on the queries to produce the appropriate kind of SQL.

Two examples of considerations of the SQL generation that take place are:

How is the business type analysis performed on the queries?
What are the basic steps of the business type analysis?

One of the key advantages of the visual representation of the different perspectives is the ability to view OR manage representations of the data over a structure. The structure may be a map, layout or hierarchy for example.

According to one example, slowly changing dimensions (SCDs) are implemented to enable data to be retrieved from specific points in time based on the location or configuration of the item or asset being analysed. It will also be understood that a SCD may also be based on variables other than location or configuration, such as version, product line, rating etc.

According to another example, an extension of the AS AT statement may be utilised to query the database. The AS AT statement is an extension to SQL that some databases support. Where this extension has been implemented then the SQL generation may use these constructs. One advantage of this implementation is that the SQL is easier to understand and the complexity of a slowly changing dimension (SCD) is shielded from the end user. The AS AT statement enables a query to be made to a database to retrieve relevant data associated with a specific point in time.

The herein described system and methods aim to solve the problem associated with structure of data values versus the data value transactions. That is, the system addresses the question: If the structure (e.g. map or hierarchy) of the data values changes, which transactions should be used by the system in order to solve the query?

For example, if an airplane no longer has first class seats it does not make any sense to include the first class fares from historic flights when looking at the rate of revenue being generated by the airplane, as these first class seats can no longer have any effect on the rate of revenue.

According to another example, a website hierarchy changes all the time. That is, the structure and content of the website are continually changing. However, a key defining characteristic of each change is that it has a start date and an end date. For current data, a future value may be allocated to the data to indicate that the data is current. Taking the airplane scenario again, the airplane may have a specific configuration of seats from a specific start date to a specific end date.

A more detailed description of the present invention is now provided.

Embodiments of the present invention are described herein with reference to a system adapted or arranged to perform a method for generating multiple perspective views of a graphical representation of data based on a single database query.

In summary, the system includes at least a processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the system may include one or more communication devices (wired or wireless) for communicating with external and internal devices, and one or more input/output devices, such as a display, pointing device, keyboard or printing device.

The processor is arranged to perform the steps of a program stored as program instructions within the memory device. The program instructions enable the various methods of performing the invention as described herein to be performed. The program instructions may be developed or implemented using any suitable software programming language and toolkit, such as, for example, a C-based language. Further, the program instructions may be stored in any suitable manner such that they can be transferred to the memory device or read by the processor, such as, for example, being stored on a computer readable medium. The computer readable medium may be any suitable medium, such as, for example, solid state memory, magnetic tape, a compact disc (CD-ROM or CD-R/W), memory card, flash memory, optical disc, magnetic disc or any other suitable computer readable medium.

The system is arranged to be in communication with external or internal data storage systems or devices in order to retrieve the relevant data. For example, an SQL database may be in communication with the system and a database analysis module may be arranged to communicate with the SQL database to retrieve data based on the SQL statements generated by the system.

It will be understood that the system herein described includes one or more elements that are arranged to perform the various functions and methods. The following portion of the description is aimed at providing the reader with an example of a conceptual view of how various modules and/or engines that make up the elements of the system may be interconnected to enable the functions to be implemented. Further, the following portion of the description explains in system related detail how the steps of the herein described method may be performed. The conceptual diagrams are provided to indicate to the reader how the various data elements are processed at different stages by the various different modules and/or engines.

It will be understood that the arrangement and construction of the modules or engines may be adapted accordingly depending on system and user requirements so that various functions may be performed by different modules or engines to those described herein, and that certain modules or engines may be combined into single modules or engines.

It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device.

The methods described herein may be implemented using a general purpose computing system specifically programmed to perform the described steps. Alternatively, the methods described herein may be implemented using a specific computer system such as a data visualization computer, a database query computer, a graphical analysis computer, a retail environment analysis computer, a gaming data analysis computer, a manufacturing data analysis computer, a business intelligence computer, a social network data analysis computer, etc., where the computer has been specifically adapted to perform the described steps on specific data captured from an environment associated with a particular field.

The data provided as an input to the system may be of any suitable type of data, for example, real world data including, but not limited to, gaming or gambling data associated with a gaming environment such as a casino, event data, test or quality control data obtained from a manufacturing environment, business data retrieved from an accounting system, sales data retrieved from a company database, data received or accumulated from a social network, etc. All this data may be received by the system in real time (e.g. by receiving streaming data) in a cache memory or may be stored in a more permanent manner.

The following example of an implementation of the herein described invention is directed at gaming floor data. However, it will be understood that the present invention may be applied to other forms of data, such as retail data, business data, social network data, manufacturing data, travel services data (e.g. flight, rail and/or vehicle travel related data) etc.

When analyzing a gaming floor it is important to determine what the question is that the person is looking to answer, as this impacts on the data requirements. When examining these questions it can be seen that there may be more than one correct answer to the question “what are the performance numbers from my gaming floor?”.

To illustrate these different perspectives, three quite different questions are analyzed.

1) From the financial perspective—e.g. how much money is my gaming floor making, and what are the contributions from individual games? For example, this may be a transaction specific query.
2) From a device perspective, such as a gaming machine or slot machine, e.g. how are my devices performing? For example, this may be a device specific query.
3) From the marketing or customer perspective, e.g. what impacts are my marketing programs or incentives having on my gaming floor? For example, this may be a location specific query.

Within the world of transaction databases typically current records of financial transactions are kept. However in the world of analytical databases it is more beneficial to put together a seamless view of the world involving where the data can be analyzed at a future point in time. For example if looking at a gaming floor from January 2009 and displaying the results on a map it is important that the map being used is correct as of January 2009. There are a number of approaches to solving this problem including the “period type” which database companies such as Teradata have implemented.

A period type typically has a beginning bound and an ending bound; both of these must be of the same type—DATE, TIME, or TIMESTAMP. A period represents a duration starting from the beginning and going up to the ending bound; period does not include the ending bound.

Using the period type the process of querying the database is much simpler as the database handles the storage of the history of the objects.

One approach is to use a slowly changing dimension (SCD). An SCD applies to a situation in which the attribute for a record can vary over time.

Consider, as an example, the case of a carded customer Harold who used to live in Las Vegas. So the initial entry in the player lookup table of Casino Silver Nugget looked like—

| Customer ID | Name | City | State |
|---|---|---|---|
| 123456 | Harold | Las Vegas | Nevada |

Harold has moved to Henderson now, and the Silver Nugget has to modify the customer table to reflect this change. This is known as the SCD problem.

There are many options for implementation of SCD, the most common one being a Type 2 SCD as shown below. These variations involve adding columns for start date and end date to the record.

The Type 2 method tracks historical data by creating multiple records in the dimensional tables with separate keys. With Type 2, unlimited history preservation is provided as a new record is inserted each time a change is made.

In the same example, if the supplier moves to Illinois, the table would look like this:

| Supplier_key | Supplier_Code | Supplier_Name | Supplier_State | version |
|---|---|---|---|---|
| 001 | ABC | Phlogistical | CA | 0 |
| | | Supply Company | | |
| 002 | ABC | Phlogistical | IL | 1 |
| | | Supply Company | | |

Another popular method for tuple versioning is to add effective date columns.

| Supplier_key | Supplier_Code | Supplier_Name | Supplier_State | Start_Date | End_Date |
|---|---|---|---|---|---|
| 001 | ABC | Phlogistical | CA | 01 Jan. 2000 | 21 Dec. 2004 |
| | | Supply Company | | | |
| 002 | ABC | Phlogistical | IL | 22 Dec. 2004 | |
| | | Supply Company | | | |

Null End_Date signifies current tuple version. In some cases, a standardized surrogate high date (e.g. 9999-12-31) may be used as an end date, so that the field can be included in an index.”

In the world of slots, the definition of a new record in the SCD is a little more complex than one would think. Following are some questions that should be considered before defining the SCD record.
Do you want to analyze the effect of change of a games location on its performance?
Do you want to see the effects of the change of denomination on game performance.
How much change in the hold % is important for analytical purposes, for example is 0.01% hold percent change important.
Should you track new chip changes to existing games?
Does it matter when new chairs are added at a location from an analytical perspective?
Does it matter if new signage is added at a location from an analytical perspective?

The challenge is that the more SCD records that are added the more fragmented the data becomes. This balance in requirements between analytical fragmentation and the questions that can be answered makes the process of answering these questions a critical part of the warehouse design. It is our recommendation that any changes to theme, location or denomination are tracked and that small adjustments to hold % (which are often corrections) are not tracked.

The alternative is to create a maximum detail SCD that tracks every change as a new record. This alternative requires that additional views of the data are created to build SCDs for the different kinds of analyses. While this maximum detail approach is very appealing, pragmatism normally rules and only one SCD is kept for analytical purposes.

The following is an example of a slot configuration SCD, where each row represents an attribute in the dimension table. The key to this dimension table is that it combines both attributes of the game and the location of the game.

### Machine Variables Table:

| | Description |
|---|---|
| MachineNumber | The unique number that identifies the machine |
| | configuration |
| MachineSerialNumber | This serial number of the machine |
| LocationID | The number of location where this machine is |
| | installed |
| MachineTheme | The name of the theme |
| MachineDenomination | The denomination that has been configured |
| MachineManufacturer | The manufacturer that built the game |
| MachinePaylines | The number of paylines on the game |
| MachineHoldPercent | The manufacturer rated hold percentage |
| StartDate | The start date of the configuration |
| EndDate | The end date of the configuration |

This configuration table is quite a simplification of the machine config table as managed by the gaming system; however it also holds the additional information that shows the location of each gaming device. In other words if a gaming device is moved it will create a new record in the SCD.

This simplification enables users to answer business questions related to changes in the attributes in question. For example, “show me the number of theme changes at this location” or by joining to the transaction table, “show me the total revenue generated by game type by location or by area of the property”.

If the LocationID is not part of the SCD then location related questions may not be possible, so it will be difficult to answer questions like, “how did the game moves affect the performance of the games?” or “how did this game perform in a different areas of the gaming floor?”.

With the buzz surrounding downloadable games and the ability to place any game at any location with the push of a button location based analysis emerges as a dimension in the gaming data. Location based questions like “how are these themes going in this location?” or “what is the best kind of theme in this location?” are difficult to answer. As downloadable games can have dramatic numbers of changes the management of the associated SCD creates a complex data management problem.

In the building of data warehouses, the data integrity questions associated with the transaction data are relatively easy to answer. For example, the actual win numbers can be added up and compared to the total revenue. However, SCDs are much more difficult to manage, for example, if location based changes are not captured accurately as they happen it is likely this information will be lost forever. If these changes are not accurately tracked then analysis that depends on the correct dimensional information may be fundamentally flawed.

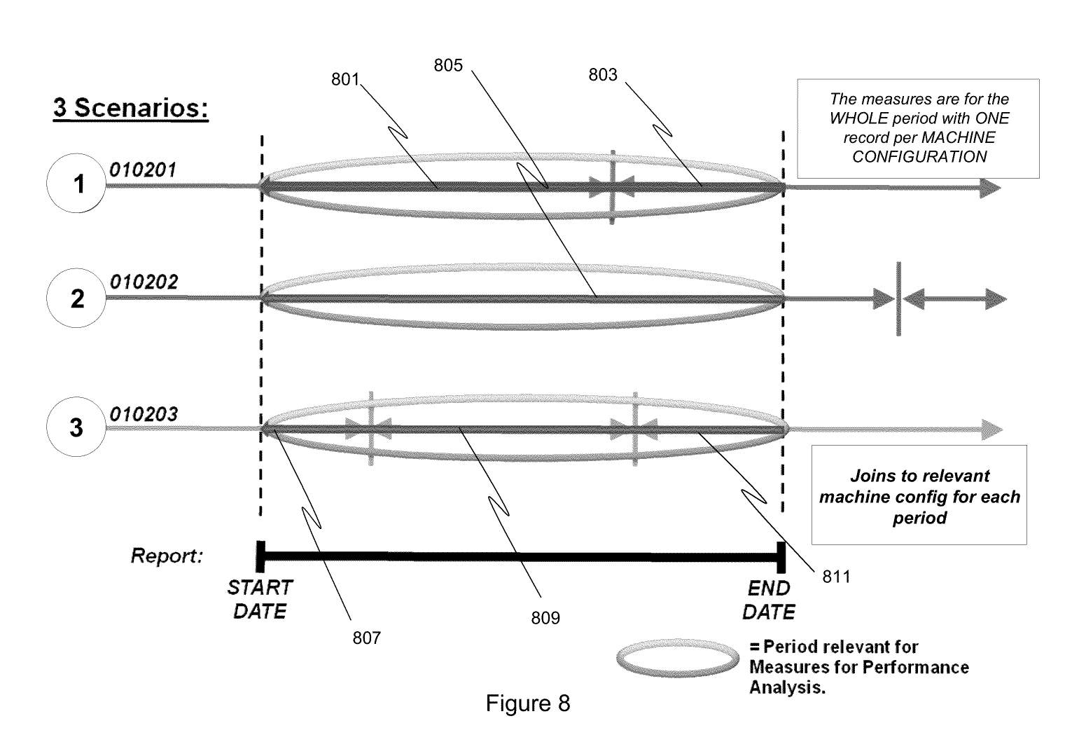

Referring to FIG. 8, which shows a view of slowly changing dimensions in association with a financial perspective of the data, an example of an implementation of the present invention is provided. This perspective is related to performance analysis.

From the financial perspective, the main question is usually “how much money is my gaming floor making?”.

These reports contain gaming machines that have been removed or reconfigured must reconcile back to the overall volume of money that is generated by the gaming floor.

The queries to generate this data include all transactions for the period and link each transaction to the SCD that is appropriate for the time. As with all things, compromises in the construction of the SCD, for example adjustments to the hold percentage, may result in variations in the final numbers.

Three machines, 1, 2 and 3 are being viewed. A number of records are recorded for the machines. That is, machine 1 has a first record 801 and a second record 803. Machine 2 has a first record 805. Machine 3 has a first record 807, a second record 809 and a third record 811. Each record indicates a particular state of the machine for a particular time period. That is, as the location or configuration of a machine changes, a new record is created. This produces slowly changing dimensions (SCDs) associated with the machines.

The circled area for each machine identifies the period or records that is relevant for the appropriate measures and performance analysis. That is, for this form of analysis, the measures that are relevant are for the whole period (between the start date and the end date) with one record per machine configuration.

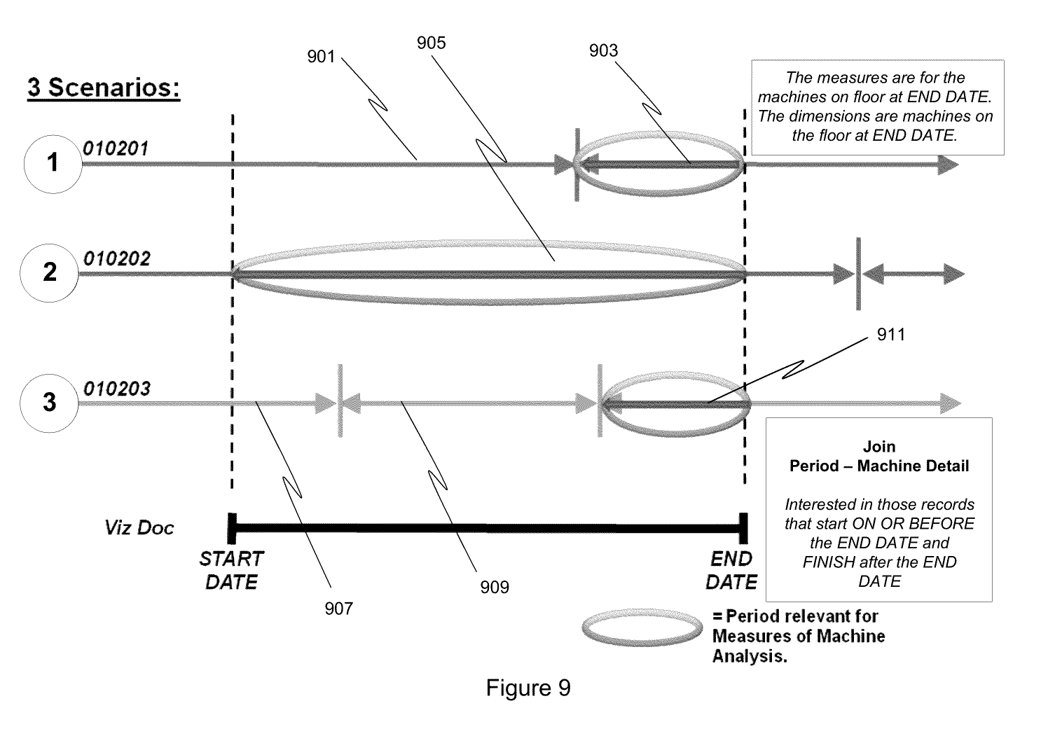

Referring to FIG. 9, which shows a view of slowly changing dimensions in association with a device specific perspective of the data, an example of an implementation of the present invention is provided. In terms of gaming devices, this perspective is related to machine analysis,

According to this perspective the key question from the slot perspective is “how are my games performing?”.

When moving to the gaming floor analysis, the current or active floor at the end point of the analysis is of greatest importance. The gaming analyst is looking at different locations on the casino floor, the different games at these locations, and the numbers they are generating on different days of the week. For gaming floor analysis we would consider it to be quite misleading to include the performance of historic games in location performance numbers.

According to this example, the Transaction data is restricted to include only values from machines and their locations at the End Date of the visualization. Common issues in the SCD here include not tracking location changes of games, if these new locations do not create new SCD records then the location performance numbers could be blend of the transactions from an old location and the new location. For example, an extreme case of this would be showing the numbers the machine generated while it was placed in the high limit room on the new location the game was moved to.

Again, three machines, 1, 2 and 3 are being viewed. A number of records are recorded for the machines. That is, machine 1 has a first record 901 and a second record 903. Machine 2 has a first record 905. Machine 3 has a first record 007, a second record 909 and a third record 911. Each record indicates a particular state of the machine for a particular time period. That is, as the location or configuration of a machine changes, a new record is created. This produces slowly changing dimensions (SCDs) associated with the machines.

The circled area for each machine identifies the period or records that is relevant for the appropriate measures and performance analysis. That is, for this form of analysis, the measures that are relevant are for the machines that are located on the gaming floor at the end date. The dimensions are machines on the floor at the end date.

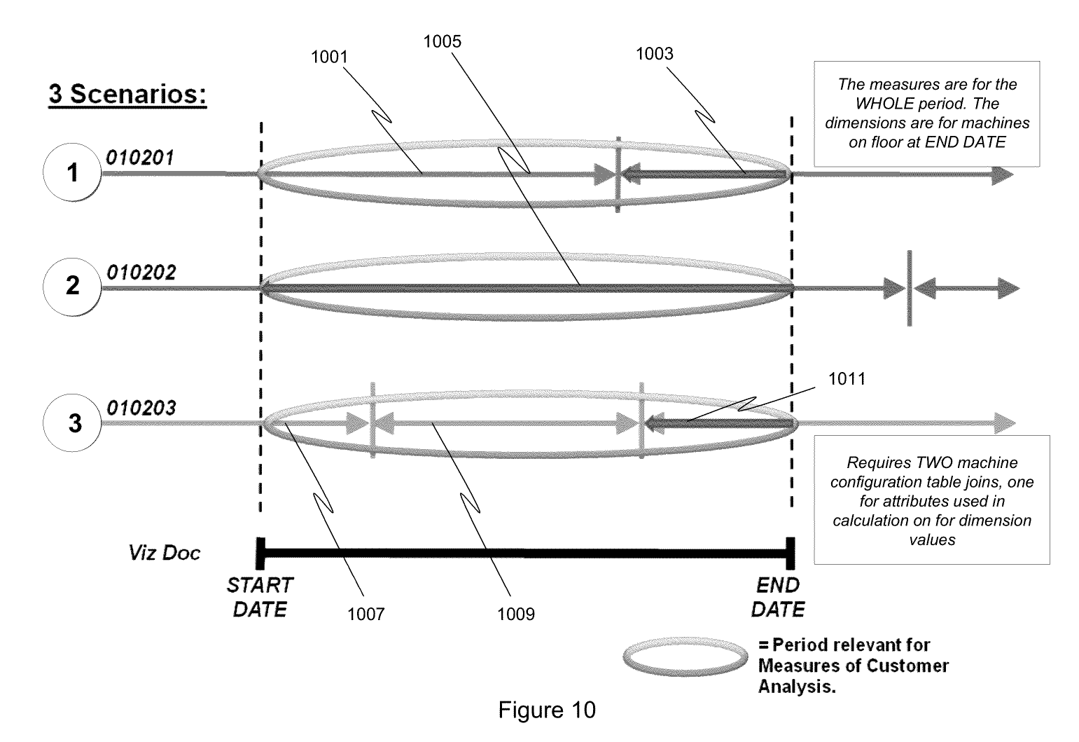

Referring to FIG. 10, which shows a view of slowly changing dimensions in association with a marketing perspective of the data, an example of an implementation of the present invention is provided. This perspective is related to a customer/consumer or marketing perspective

According to this perspective the key question from the marketing perspective is “what impacts are my marketing programs or incentives having on my gaming floor?”.

Now enter the marketing department and the questions become quite different. The marketing analyst is asking “where did my loyalty or incentive dollars get redeemed?” or “where did players who responded to my marketing program play on the gaming floor?”. The marketing person is unlikely to ask to be shown the transactions of only players who played on games that have not been changed by slots.

This quite different question requires quite a different analysis, for this analysis we are only interested in locations on the floor at the end point of the analysis, and we typically do not wish to restrict the analysis to only games at these locations. The Transaction Data is shown at the location that it occurred, irrespective of the games that were at the location at the time.

Again, three machines, 1, 2 and 3 are being viewed. A number of records are recorded for the machines. That is, machine 1 has a first record 1001 and a second record 1003. Machine 2 has a first record 1005. Machine 3 has a first record 1007, a second record 1009 and a third record 1011. Each record indicates a particular state of the machine for a particular time period. That is, as the location or configuration of a machine changes, a new record is created. This produces slowly changing dimensions (SCDs) associated with the machines.

The circled area for each machine identifies the period or records that is relevant for the appropriate measures and performance analysis. That is, for this form of analysis, the measures that are measures are for the whole period. The dimensions are machines on the floor at the end date.

The correct management of the SCD enables the answering of questions relating to how the gaming floor is being managed and the impacts of configuration changes and location moves.

As illustrated above, each of the perspectives is correct. Each perspective will generate different data sets, and is only right for the questions that are being asked.

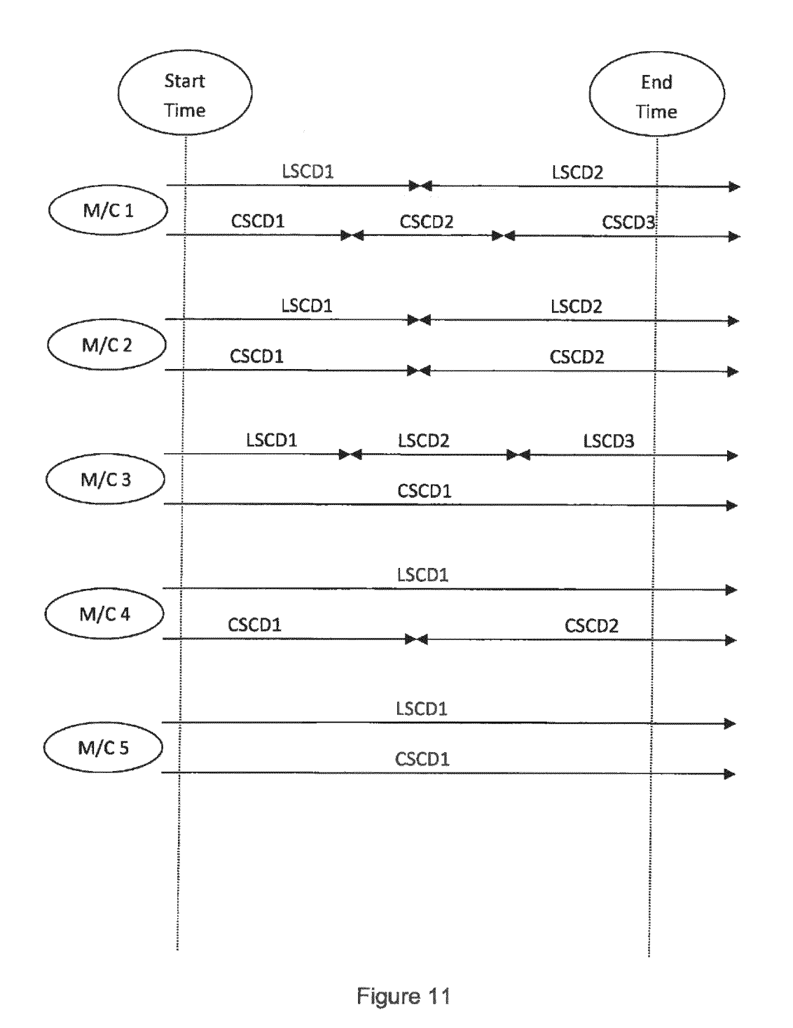

FIG. 11 shows a further example with more details of various SCDs (location and configuration) for different machines. It will be understood that the SCDs generated may relate to any type of variable feature associated with the machines, including but not limited to those listed in the machine variables table above.

For example, machine 1 has a number of location SCDs that are created each time the machine is moved to a new location. It also has associated with it a number of configuration SCDs that are generated each time the machine's configuration is changed. For machine 1, it can be seen that the machine has been relocated once hence the creation of LSCD2. Also, for machine 1, the configuration has been changed quite regularly to create three separate configurations SCDs: CSCD1, CSCD2 & CSCD3.

Machine 2 has also been relocated once to create two location SCDs. The configuration of machine 2 was also changed to create CSCD2 when the machine was relocated.

Machine 3 was relocated twice within the time period shown to create three different location SCDs. However, the configuration of the machine remained constant during this time period.

Machine 4 remained in one location during the time period shown. However, its configuration changed once halfway through the time period.

Machine 5 was neither moved nor had a change in configuration during the time period shown.

Therefore, for the various different types of analysis, different SCDs would be retrieved and analyzed to generate the multiple perspectives of the data.

For example, for performance analysis, all transactions would be retrieved that have occurred or are occurring between the start and end times of the period shown for each machine.

As a further example, for machine analysis, the transactions used are the most current SCDs. That is, for machine 1, LSCD2 (not LSCD1) would be used and CSCD3 (not CSCD1 or CSCD2) would be used.

As a further example, for customer analysis, only transactions from the location SCDs could be used. All transactions for all LSCDs within the time period could be used.

### FURTHER EMBODIMENTS

It will be understood that the embodiments of the present invention described herein are by way of example only, and that various changes and modifications may be made without departing from the scope of invention.

1. In a data visualisation system, a method of generating multiple perspective views of a graphical representation of data based on a single database query, the method comprising the steps of:
receiving a database query,
determining the query data associated with the database query
retrieving the query data from a data storage module that is in communication with the data visualisation system,
generating multiple perspective query results from the database query, and
generating a graphical representation based on one or more of the multiple perspective query results.

2. The method of claim 1, wherein each of the multiple perspective query results retrieves measures for a defined period or point in time based on the perspective of the query result.

3. The method of claim 1, wherein each of the multiple perspective query results retrieves dimensions associated with the defined period or point in time based on the perspective of the query result.

4. The method of claim 1, wherein the multiple perspective query results include query results based on two or more of a performance analysis, machine analysis, location analysis, asset analysis, call pattern analysis, and customer analysis.

5. The method of claim 1, wherein the step of generating multiple perspective query results comprises the steps of
identifying a time period for analysis,
identifying transactions or measures that are associated with the time period,
identifying one or more slowly changing dimensions (SCDs) that are active within the defined time period,
linking the identified transactions to the active SCDs, and
applying the linked transactions to produce the analytical perspective.

6. The method of claim 1, wherein the SCD is a location SCD.

7. The method of claim 6, wherein the location SCD records changes to the location of a device.

8. The method of claim 1, wherein the SCD is a configuration SCD.

9. The method of claim 8, wherein the configuration SCD records changes to the configuration of a device.

10. The method of claim 9, wherein the configuration SCD is associated with a single device or group of devices.

11. The method of claim 10, wherein the device is a device or system comprising of one or more of: a gaming device; a retail outlet device; a data recording device; a manufacturing device or system; slot machine device; a cell phone; a smart phone; a traffic counting system; a medical scanning device; an air travel booking system.

12. The method of claim 1, wherein the identified time period wholly encompasses the active SCDs.

13. The method of claim 1, wherein the active SCDs are partially active outside of the identified time period.

14. The method of claim 1, wherein the active SCDs are only active within the identified time period.

15. The method of claim 1, wherein all transactions within the identified time period are retrieved to produce the analytical perspective.

16. The method of claim 1, wherein all transactions within the identified time period are linked to one or more active SCDs.

17. The method of claim 1, wherein the step of identifying SCDs comprises the step of identifying a plurality of location SCDs.

18. The method of claim 1, wherein the step of identifying SCDs comprises the step of identifying a plurality of configuration SCDs.

19. The method of claim 1, wherein the step of applying the linked transactions comprises: applying the linked transactions that are linked to an active SCD that is current at the end of the identified time period to produce the analytical perspective.

20. The method of claim 1, wherein the step of linking the identified transactions comprises: linking the identified transactions that are associated with an active SCD that is current at the end of the identified time period.

21. The method of claim 1, wherein the step of identifying transactions further comprises the step of identifying transactions associated with an active SCD that is current at the end of the identified time period.

22. The method of claim 1, wherein the step of identifying one or more SCDs comprises the step of identifying the SCD that is current at the end of the identified time period.

23. The method of claim 1, wherein the step of identifying SCDs comprises the step of identifying a single location SCD.

24. The method of claim 1, wherein the step of identifying SCDs comprises the step of identifying a single configuration SCD.

25. The method of claim 1, wherein the step of applying the linked transactions comprises: applying the linked transactions that are linked to an active location SCD that is current at the end of the identified time period to produce the analytical perspective.

26. The method of claim 1, wherein the step of linking the identified transactions comprises: linking the identified transactions that are associated with an active location SCD that is current at the end of the identified time period.

27. The method of claim 1, wherein the step of identifying transactions further comprises the step of identifying transactions associated with an active location SCD that is current at the end of the identified time period.

28. The method of claim 1, wherein the step of identifying one or more SCDs comprises the step of identifying a location SCD that is current at the end of the identified time period.

29. The method of claim 1, wherein the step of identifying SCDs comprises the step of identifying a single location SCD and identifying a plurality of configuration SCDs associated with the identified location SCD.

30. A graphical visualization system arranged to perform the method of claim 1.
